(19) United States
(12) Patent Application Publication
(10) Pub. No.: US 2026/0195582 A1
(43) Pub. Date: Jul. 9, 2026

(54) SYSTEM AND METHOD FOR EFFICIENT LINEAR FAST ATTENTION FOR VISION TRANSFORMER (ELFATT)

(71) Applicant: Centre for Intelligent Multidimensional Data Analysis Limited, Pak Shek Kok (HK)

(72) Inventors: Chong Wu, Pak Shek Kok (HK); Maolin Che, Pak Shek Kok (HK); Renjie Xu, Pak Shek Kok (HK); Zhouheng Ran, Pak Shek Kok (HK); Hong Yan, Pak Shek Kok (HK)

(21) Appl. No.: 19/011,779

(22) Filed: Jan. 7, 2025

(51) Int. Cl. G06N 3/08; G06N 3/0455

(52) U.S. Cl. CPC G06N 3/08; G06N 3/0455

(57) ABSTRACT

A system and method for efficient linear fast attention for vision transformer includes a processor to perform steps of: accessing a machine-learned model including: at least one encoder or one decoder, wherein the encoder is adapted to receive input embeddings to generate an encoded output, the decoder is adapted to receive output embeddings to generate a decoded output; wherein the encoder or the decoder includes an attention network for receiving token embeddings to generate an attention matrix by carrying out the steps of: generating a query, a key, and a value from token embeddings; splitting the query, the key, and the value; generating a global linear attention from the query matrix, generating a sparse blockify attention from the second query matrix, the second key matrix, and the second value matrix; generating attention matrix by concentrating the sparse blockify attention and the global linear attention.

### TECHNICAL FIELD

This invention relates to a method and system of Efficient Linear Fast Attention for Vision Transformer.

### BACKGROUND

System and method of transformers have achieved great success in large language models (ChatGPT [1] and Llama [2]) and large vision models (SAM [3] and Sora [4]). The core technique of the transformer, the vanilla softmax-based attention mechanism, is capable of capturing the relationship between any two tokens [5]. In complex tasks, the sequence length becomes longer and longer, usually much longer than the embedding dimension. The softmax operation after the multiplication of query and key matrices makes the vanilla softmax-based attention mechanism quadratic computational complexity with respect to the sequence length. It has become a main obstacle to computational efficiency.

Acceleration methods to speed up the attention computation can be classified into two categories: (1) memory-efficient methods; (2) computation-efficient methods. Memory-efficient methods focus on optimizing memory input/output (I/O) operations to achieve almost linear complexity [6]-[9]. FlashAttention [6]-[8] and FlashSigmoid [9] are representatives of memory-efficient methods. Computation-efficient methods focus on minimizing the computation bound of the attention computation by using linear approximations based on different kernel methods [10]-[19], low-rank decomposition [5], [15], [20], [21], and sparse computation [22]-[30]. However, memory-efficient methods still have quadratic computational complexity, and computation-efficient methods usually have lower performance compared to the vanilla softmax-based attention mechanism.

### SUMMARY OF THE INVENTION

According to a first aspect of the invention, there is provided a method of an efficient linear fast attention (ELFATT) mechanism to replace the typical attention mechanism in a machine learning transformer.

According to a second aspect of the invention, there is provided a system for improving the performance of an artificial intelligence engine with an efficient linear fast attention (ELFATT) mechanism that has low memory I/O operations and linear computational complexity.

In an embodiment of the first aspect, there is provided a system comprising:
a processor configured to execute instructions;
a computer-readable medium containing instructions for execution on the processor, the instructions causing the processor to perform steps of:
accessing a machine learning model including:
at least one encoder or one decoder, wherein the encoder is adapted to receive input embeddings to generate an encoded output, the decoder is adapted to receive output embeddings to generate a decoded output;
wherein the encoder or the decoder comprises an attention network for receiving token embeddings H to generate an updated embedding matrix by carrying out the steps of:
generating a query, a key, and a value from token embeddings;
splitting the query Q into a first query matrix Q̅ and a second query matrix \tilde{Q}, the key K into a first key K̅ matrix and a second key matrix \tilde{K}, and the value V into a first value matrix V̅ and a second value matrix \tilde{V};
generating a first embedding matrix H̅ using global linear attention from the first query matrix Q̅, the first key matrix K̅, and the first value matrix V̅;
generating a second embedding matrix \tilde{H} using sparse blockify attention from the second query matrix \tilde{Q}, the second key matrix \tilde{K}, and the second value matrix \tilde{V};
generating a third embedding matrix H by concentrating the first embedding matrix H̅ and the second embedding matrix \tilde{H}.

In a preferred embodiment, wherein the query, the key, and the value have same dimensions (m×c).

In a preferred embodiment, the first query matrix Q̅, the first key matrix K̅, and the first value matrix V̅ have same dimensions (m×c₁), and wherein the second query matrix \tilde{Q}, the second key matrix \tilde{K}, and the second value matrix \tilde{V} have same dimensions (m×c₂) such that c=c₁+c₂.

In a preferred embodiment, the second embedding matrix \tilde{H} is generated by applying a blockify function ƒ(⋅) for separating the second query matrix \tilde{Q}, the second key matrix \tilde{K}, and the second value matrix \tilde{V} with a size of m×c₂ into b blocks (each block has a size of

$$( \frac{m}{b} ) \times {c}_{2} ) .$$

In a preferred embodiment, the second embedding matrix \tilde{H} is generated by applying a unblockify function g(⋅) to unblock b blocks of embedding matrices derived from the blockified matrices (ƒ(\tilde{Q}), ƒ(\tilde{K}), and ƒ(\tilde{V})) to a single matrix with a size of m×c₂.

In a preferred embodiment, the sparse blockify attention \tilde{H} is generated by (exp(\tilde{Q}\tilde{K}^{τ})⊙Z)\tilde{V}, wherein ⊙ denotes a Hadamard product, Z∈ [symbol] is a matrix where Z=I_{b}⊗U_{(m/b)}, ⊗ denoting the Kronecker product, and U_{(m/b)} ∈ [symbol] being the all-ones matrix.

In a preferred embodiment, the first embedding matrix H̅ is an embedding matrix such that H̅=exp(Q̅K̅^{τ})V̅.

In a preferred embodiment, the first embedding matrix H̅ is an embedding s such that H̅=exp(Q̅)exp(K̅)^{τ}V̅.

In a preferred embodiment, the attention network comprises a locally enhanced positional encoding (LePE) mechanism [23] wherein the locally enhanced positional encoding comprises the step of carry out a depthwise convolution operation L( ).

In a preferred embodiment, the sparse blockify attention \tilde{H} is generated by applying a blockify function ƒ(⋅) for the value before carrying out the depthwise convolution operation L(⋅), such that \tilde{H}=g(exp(ƒ(\tilde{Q})ƒ(\tilde{K})^{τ})ƒ(\tilde{V})+L(ƒ(\tilde{V}))).

In an embodiment of the second aspect, there is provided a method, comprising:
accessing a machine learning model in a processor wherein the process comprising memory with a finite size:
receiving input embeddings for at least one encoder to generate an encoded output, or receiving output embeddings for at least one decoder to generate a decoded output;
receiving token embeddings to generate an updated embedding matrix by an attention network in the encoder or decoder by carrying the steps of:
generating a query Q, a key K, and a value V from token embeddings H;
splitting the query Q into a first query matrix Q̅ and a second query matrix \tilde{Q}, the key K into a first key K̅ matrix and a second key matrix \tilde{K}, and the value V into a first value matrix V̅ and a second value matrix \tilde{V};
generating a first embedding matrix H̅ from the first query matrix Q̅, the first key matrix K̅, and the first value matrix V̅ using global linear attention;
generating a second embedding matrix \tilde{H} from the second query matrix \tilde{Q}, the second key matrix \tilde{K}, and the second value matrix \tilde{V} using sparse blockify attention;
generating the updated embedding matrix H by concentrating the first embedding matrix H̅ and the second embedding matrix \tilde{H} on the column dimension.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example, with reference to the accompanying drawings in which:

FIG. 1 is a schematic diagram of a computer system to implement the efficient linear fast attention (ELFATT) mechanism enabled artificial intelligence in accordance with an embodiment of the present invention.

FIG. 2 is a schematic diagram of a tensor processor 200 for executing a system comprising an artificial intelligence engine with ELFATT of an embodiment of the present invention

FIG. 3, at part 3A is a schematic diagram of a vanilla attention mechanism of a typical machine learning engine of the prior art, and, at part 3B, is a schematic diagram of an attention network for implementing ELFATT in accordance with an embodiment of the present invention.

FIG. 4 shows a visual comparison of class activation map (CAM) based attention results of different attention mechanisms obtained using Score-CAM [31].

FIG. 5 shows a visual comparison of class activation map (CAM) based attention results of different attention mechanisms obtained using Score-CAM [31].

### DETAILED DESCRIPTION OF THE PREFERRED EMBODIMENT

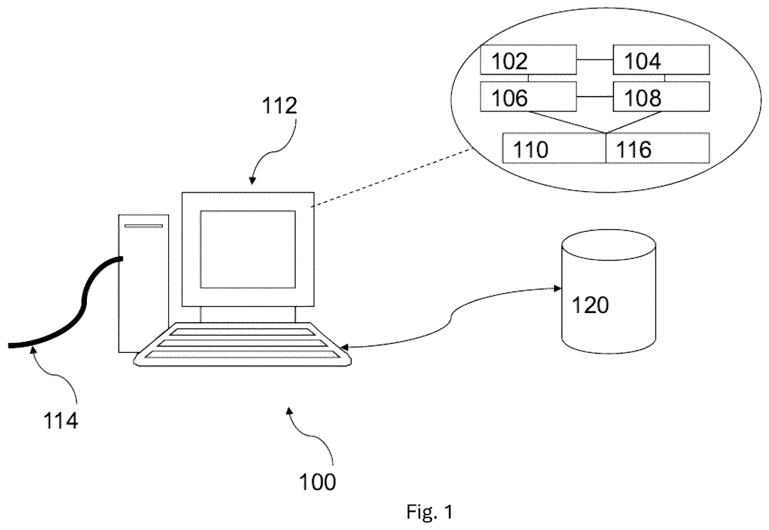

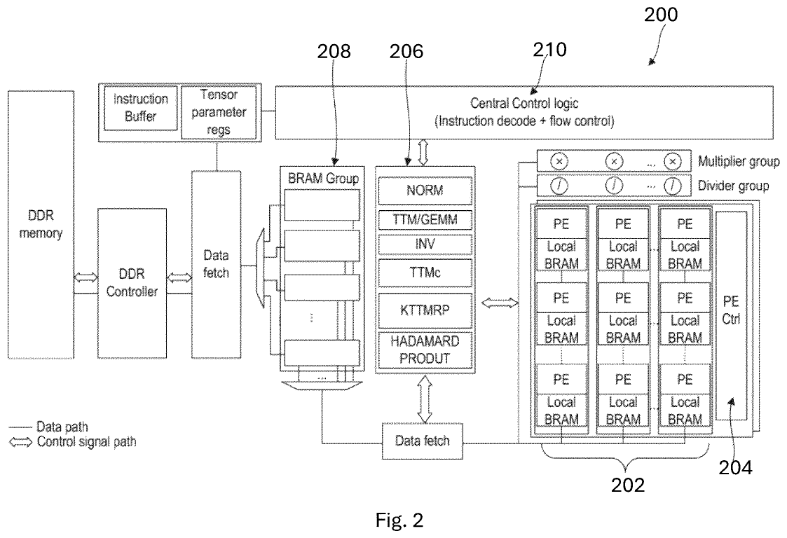

With reference to FIGS. 1 and 2, an embodiment of the present invention is illustrated. This embodiment is arranged to provide a system and method for

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IoT) devices, edge computing devices, client/server architecture, “dumb” terminal/mainframe architecture, cloud-computing based architecture, or any other appropriate architecture. The computing device may be appropriately programmed to implement the invention.

Turning first to FIG. 1, there is a schematic diagram of a computer system or server 100 to implement the efficient linear fast attention (ELFATT) mechanism enabled artificial intelligence in accordance with an embodiment of the present invention. The efficient linear fast attention of the present invention can be implemented to replace the vanilla attention mechanism for use in artificial intelligence engine adapted for natural language processing, computer vision, etc.

This embodiment comprises a server 100 which includes suitable components necessary to receive, store and execute appropriate computer instructions. The components may include a processing unit 102, including Central Processing Units (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114 may also be present. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may also include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system 116 which resides on the disk drive or in the ROM of the server 100.

The computer or computing apparatus may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

Turning first to FIG. 2, there is a schematic diagram of a tensor processor 200 for executing a system comprising an artificial intelligence engine with ELFATT of an embodiment of the present invention. This embodiment comprises a tensor processor 200 which includes suitable components necessary to receive, store, and execute appropriate computer instructions. The components may comprise: two processing element arrays 202, the array having a plurality of processing elements arranged to individually perform operations on variables of a tensor, wherein all the processing elements within a processing element array are individually controlled by a processing element controller 104 to perform tensor operations on a tensor.

In this example embodiment, the processor 200 is arranged specifically to perform instruction and parameters fetch, instruction decode, schedule the tensor operations. Tensor calculations refer to the processing of tensors or tensor data structures which are also referred to, within the field of computer sciences, as multi-dimension arrays (or nth dimension arrays).

In this example embodiment, as shown in FIG. 2, the tensor processing unit (TPU) or tensor processor 200 is implemented to include two arrays of processing elements (PE) array 202, and thus is an example of a processor 200 which includes a PE array architecture 202. The arrays 202 is a type of in memory computing, where all the local copy of data are near the operators in a processing element. In one preferred embodiment, there is provided 8 groups of BRAMs 208 were implemented to store data.

Preferably, the PE within PE arrays (e.g. 202) may include an adder, multiplier and input memory and output memory in its base unit, together with multiple multiplexers arranged to be controlled by a processing elements controller so as to perform the double buffering for the results. As it will be described below in details with reference to FIG. 2, this array of processing elements 202 may be controlled in such a way that the processing elements inside the PE array 202 may function as two or more parallel arrays of processing elements which may then operate to process the divided components of a tensor, and thus effectively dividing the tensor calculation into multiple parallel components. By this way, each processing element array may be able to process such small block of data. The small blocks may also enable the pipeline architecture for the two processing element arrays design. The small blocks can also be processed in different processing element array independently. The number of the processing elements in the two arrays are set to be different which taking work-load balance in consideration.

As is the case with tensor calculation, due to its multi-dimensional characteristics, the results may be accumulated, to create the final result.

Once each of the factorized terms or components are processed by each PE array, the results may then be accumulated into a final result which would then be the complete result of the tensor calculation. This process is done by the multiplexers. The enable signal of the multiplexers are generated by the processing element controller 204. Once the accumulated process needs to be started, all the multiplexers for re-route will be enabled. The wiring is changed, so that when the processing element controller fetch the data and feed to the data bus, the data will be redirected after they passed the multiplexers, which is denoted as the re-route process of the data flow among the local memory and operators within one processing element column. This process makes the in-memory computing feasible. Since the intermediate result computed in previous stage which is located in the local memory of the processing element array can be accumulated in the same computing architecture, there is no time consumption to transfer the data to another accumulation architecture and do the same thing.

In order to operate the Processing Element Controller so as to perform the tensor calculations by using the same processing element array structure, the processor includes six major tensor manipulation modules 206 which would instruct the PE controller 204. These major tensor manipulation 206 modules include:
A NORM module for performing a maximum normal of each column of a matrix and for performing a Euclidean normal of each column of a matrix;
A TTM/GEMM module for performing Tensor Matrix and Matrix-Matrix Multiplication;
A INV module for performing matrix inversions;
A TTMc module for performing tensor times matrices chain (TTMc) operations;
A MTTKRP module for performing matrized tensor times Khatro-Rao product operations; and,
A HADAMARD PRODUCT module for performing Hadamard product operations.
A KRONECKER PRODUCT module for performing Kronecker product operations (not shown).

In this embodiment, these modules 206 are each arranged to perform a specific matrix calculation by controlling the PE controller 204, which will in turn control the PE arrays 202 to perform the actual calculations as required. During these operations, the PE controller 204 may be specifically instructed by each of these modules 206 to perform any necessary decomposition to the tensors so as to take advantage of the unique structure of the tensor processor 200 to perform the calculations. The modules are instructed to operate via an associated instruction set 210 which will be used or implemented in a program by a programmer or a compiler. The present invention of Efficient Linear Fast Attention for Vision Transformers is particular able to harness the design of this type of TPU with computation bound and memory bound.

In this example, the central control module 210 is used to decode the instructions, issue start signal to different functional modules 206, send the corresponding parameters to the six tensor manipulation modules 206, and also to monitor the status of the whole execution. The PE module 202 is the part that comprises the actual computation units, and it is controlled by the six tensor manipulation modules 206 which will also control the PE controller 104 to implement different computations. In this arrangement, there are two PE groups 202 with any number of PEs within each group. Each of the two PE group can execute different Matrix operations in parallel and independent to one another.

For example, a transformer of the present invention may receive a sequence of input embeddings that represent a query, a key, and a value and generate a sequence of output embeddings that represent a response to the input embeddings. As another example, the transformer model may receive a sequence of input tokens that represent a paragraph in Chinese and generate a sequence of output tokens that represents a translation of the paragraph or sentence in English. As yet another example, the transformer model may receive a sequence of input tokens that represent an image and generate a label that classify the image.

In one embodiment, the computer system 200 includes one or more execution engines that are built on specialized hardware accelerators such as graphics processing units (GPU's) or tensor processor 200. The requests are executed on the execution engines. Specifically, execution of machine learning neural network models, such as transformer models, involve a significant number of operations, such as tensor multiplication between input data and high-dimensional weight tensors that can be computationally intensive. The hardware accelerators of the execution engines may be optimized to perform these operations efficiently by parallel processing, leading to significant improvement in latency or throughput when the number of parameters in the transformer model are large. However, the computer system 100 and tensor processor 200 have finite memory space.

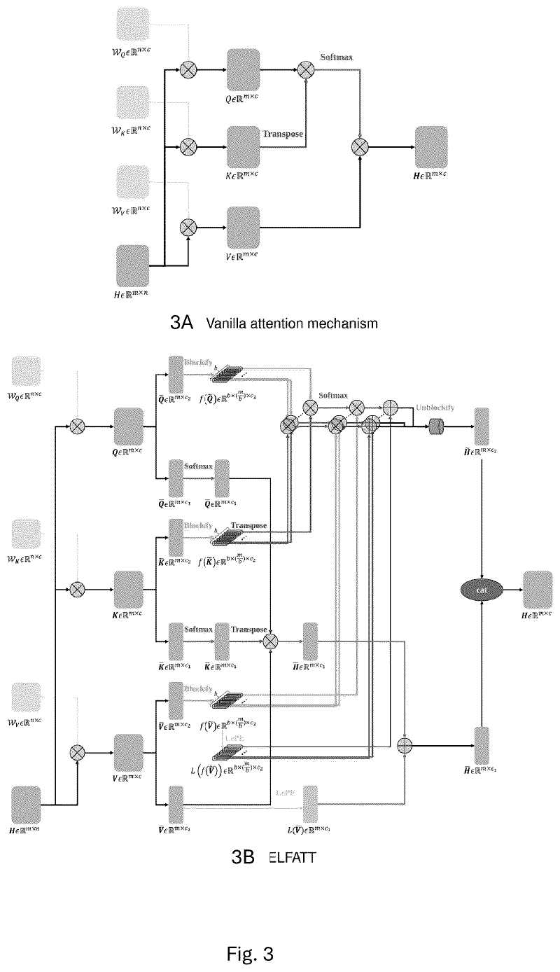

FIG. 3, part 3A, is a schematic diagram of the vanilla attention mechanism of a typical machine learning engine of the prior art. FIG. 3, part 3B, is a schematic diagram of an attention network for implementing ELFATT in accordance with an embodiment of the present invention.

FIG. 3 thus provides a comparison of the vanilla attention mechanism and ELFATT of the present invention. The term “cat” in FIG. 3 denotes a concatenation operation for concatenating two matrices on the column dimension into a single matrix.

In one embodiment, the system 100 may comprise a processor 102 configured to execute instructions implementing the ELFATT mechanism as shown in FIG. 3 in accordance with an embodiment of the present invention. The processor may be a tensor processor 200 as shown in FIG. 2. A computer-readable medium 104, 106, 108 containing instructions for execution on the processor 102. The instructions may cause the processor 102 to perform steps of: accessing a machine learning model including: at least one encoder or one decoder, wherein the encoder is adapted to receive input embeddings to generate an encoded output, the decoder is adapted to receive output embeddings to generate a decoded output.

The encoder or the decoder comprises an attention network 300 as shown in FIG. 3, part 3B, for receiving token embeddings to generate an updated embedding matrix. As presented in part 3B, the attention network is adapted to carry out the steps of:
generating a query Q, a key K, and a value V from token embeddings H;
splitting the query Q into a first query matrix Q̅ and a second query matrix \tilde{Q}, the key K into a first key K̅ matrix and a second key matrix \tilde{K}, and the value V into a first value matrix V̅ and a second value matrix \tilde{V};
generating a first embedding matrix H̅ from the first query matrix Q̅, the first key matrix K̅, and the first value matrix V̅ using global linear attention;
generating a second embedding matrix \tilde{H} from the second query matrix \tilde{Q}, the second key matrix \tilde{K}, and the second value matrix \tilde{V} using sparse blockify attention;
generating the updated embedding matrix H by concentrating the first embedding matrix H̅ and the second embedding matrix \tilde{H} on the column dimension.

Preferably, the first embedding matrix H̅ and the second embedding matrix \tilde{H} should be generated in two parallel heads. The tensor processor 200 provides an example architecture for carrying out these two processes in parallel.

As shown in FIG. 3, part 3B, the query, the key, and the value have same size (m×c). This size may be too large to be store in the local memory of the system 100 or tensor processor 200. As such, it will take a lot of reading and writing to data storage 108.

After splitting, the first query matrix Q̅, the first key matrix K̅, and the first value matrix V̅ have the same size (m×c₁), and wherein the second query matrix \tilde{Q}, the second key matrix \tilde{K}, and the second value matrix \tilde{V} have the same size (m×c₂), such that c=c₁+c₂. As such, the split matrices can be easily processed in local memory of the system 100 or tensor processor 200.

The matrices can further be broken down by blockify function ƒ(⋅). The blockify function is adapted to separate the second query matrix \tilde{Q}, the second key matrix \tilde{K}, and the second value matrix \tilde{V} with a size of m×c₂ into b blocks (each block has a size of (m/b)×c₂). After generating updated embedding matrices with the blockified matrices, an unblockify function g(⋅) to unblock b blocks of updated embedding matrices derived from the blockified matrices (ƒ(\tilde{Q}), ƒ(\tilde{K}), and ƒ(\tilde{V})) to a single matrix with a size of m×c₂.

The first embedding matrix H̅ is an embedding matrix such that H̅=exp(Q̅)exp(K̅)^{τ}V̅. Alternatively, the second embedding matrix \tilde{H} is equivalent to (exp(\tilde{Q}\tilde{K}^{τ})⊙Z)\tilde{V}, wherein ⊙ denotes a Hadamard product, Z∈ [symbol] is a matrix where Z=I_{b} ⊗U_{(m/b)}, ⊗ denoting the Kronecker product, and U_{(m/b)} ∈ [symbol] being the all-ones matrix. As disclosed in FIG. 2, the tensor processor 200 is adapted to execute the Hadamard product and Kronecker product with the parallel PE blocks.

To handle computer vision tasks, the attention network 300 comprises a locally enhanced positional encoding (LePE) mechanism [23] wherein the locally enhanced positional encoding comprises the step of carry out a depthwise convolution operation L( ). In this case, the first embedding matrix H̅ and the second embedding matrix \tilde{H} are generated by applying a blockify function ƒ(⋅) for the value before carrying out the depthwise convolution operation L( ), such that H̅=exp(Q̅)exp(K̅)^{τ}V̅+L(V̅) and \tilde{H}=g(exp(ƒ(\tilde{Q})ƒ(\tilde{K})^{τ})ƒ(\tilde{V})+L(ƒ(\tilde{V}))) as shown in FIG. 3, part 3B.

The present invention provides a novel efficient linear fast attention (ELFATT) mechanism that has low memory I/O operations and linear computational complexity and maintains non-inferior performance compared to the vanilla softmax-based attention mechanism.

The core idea of ELFATT is the combination of sparse computation with a linear approximation. Each ELFATT block has two parallel attention heads. One head is used to compute sparse blockify attention to introduce inductive biases, and the other head is used to compute global linear attention to capture long-range dependencies.

Both heads have almost linear complexity, and the sparse blockify attention process can be further speeded up by using the HashAttention [6]-[8] mechanisms to reduce memory I/O operations. ELFATT is evaluated on different vision tasks: image classification, semantic segmentation, and object detection. Compared to state-of-the-art memory-efficient acceleration methods and computation-efficient acceleration methods, ELFATT inherits advantages of both two kinds of methods: noninferior performance compared to the vanilla softmax-based attention mechanism, low memory I/O operations, and linear computational complexity. In summary, the present invention has the following contributions.
(i) A novel efficient linear fast attention (ELFATT) mechanism is proposed that has low memory I/O operations and linear computational complexity and maintains noninferior performance compared to the vanilla softmax-based attention mechanism.
(ii) The relationship between the proposed ELFATT mechanism and the vanilla softmax-based attention mechanism is analyzed and given.
(iii) An upper bound is given for the use of the proposed ELFATT mechanism to approximate the vanilla softmax based attention mechanism.
(iv) ELFATT offers 4-7× speedups over the vanilla softmax-based attention mechanism without using FlashAttention-2 and 2-3× speedups over the vanilla softmax-based attention mechanism using FlashAttention-2 on high-resolution vision tasks.

### Memory-Efficient Attention Acceleration Methods

Memory-efficient attention acceleration methods focus on optimizing quadratic memory complexity to almost linear complexity. One of the most representative methods is FlashAttention [6], which minimizes memory I/O access for the softmax computation of query and key matrices to improve the utilization rate of GPUs to achieve almost linear memory complexity [5], [6]. FlashAttention-2 further reduces the number of floating point operations (FLOPs) of non-matrix multiplication, parallelizes both forward and backward processes according to the sequence length, and reduces the I/O access of shared memory [7]. FlashAttention-3 is proposed to fully utilize the performance of new Hopper GPUs by introducing warp-specialization, interleave block-wise matrix multiplication and softmax operations, and the support of FP8 precision [8]. FlashSigmoid investigates the feasibility of using the sigmoid function to replace the softmax function in attention computation, proposes a new regularity method for sigmoid attention to stabilize training, and introduces a memory-efficient version based on FlashAttention-2 [9]. However, these memory-efficient attention acceleration methods are usually hard-aware and cannot support all kinds of GPUs and their computation complexity is still quadratic.

### Computation-Efficient Attention Acceleration Methods

Different to hardware-aware memory-efficient attention acceleration methods, computation-efficient attention acceleration methods focus on optimizing computational complexity by linear approximations and usually can be categorized into three classes: (a) kernel methods; (b) low-rank decomposition based methods; (c) sparse methods.

Kernel methods usually change the order of nonlinear normalization and multiplication of the query matrix and key matrix to achieve linear computational complexity. FLatten [10] introduces a cubic rectified linear unit (ReLU) [32] based feature map and uses it to perform nonlinear normalization on the query matrix and key matrix, respectively, before the attention computation. The linear transformer [13] introduces a feature map based on the exponential linear unit (elu) [33] activation function. cosFormer [17] introduces a cos-based nonlinear feature map to obtain a linear approximation of the vanilla softmax-based attention mechanism. Efficient attention [18] performs softmax normalization on the query matrix and the key matrix, respectively, to achieve linear complexity [18]. However, this linearization introduces noise from two aspects: (1) Separated softmax normalization will reduce the similarity of elements in the query matrix and key matrix that are both negative at the same position; (2) Large negative values are suppressed to small positive values. The above two types of noise result in decreased discrimination between tokens and incorrect concentration of attention. Agent [19] introduces a small agent matrix, which is obtained by performing the pooling operation on the query matrix. This agent matrix is used as the auxiliary key matrix to be multiplied with the query matrix to reduce its dimensions before the softmax normalization. Similarly, it is also used to reduce the dimension of the key matrix before its softmax normalization. This agent matrix served as a bridge between two independent softmax normalization processes to reduce noise.

Low-rank decomposition based methods usually take the softmax normalization of the product of query and key matrices as a whole for decomposition. Nyströmformer [21] introduces Nyström approximation to perform low-rank decomposition of the softmax normalization of the product of query and key matrices. For calculating an attention score matrix, it needs to perform an iterative inverse approximation and operate softmax normalization three times (each softmax normalization still involves a product of two matrices), which makes its acceleration effect not significant. Skeleton decomposition-based self-attention uses a simplified inverse approximation method based on the permuted diagonal matrix [20]. Interactive multihead self-attention (iMHSA) introduces several linear layers to perform head interactions instead of performing an iterative inverse approximation [34]. CUR decomposition based self-attention (CURSA) [5] introduces the CUR decomposition to replace the Nyström approximation and reduces the number of matrix multiplication.

Sparse methods usually separate the original sequences into smaller blocks using sliding windows and perform attention computation within these blocks to reduce complexity. Each token in a sequence is only affected by several tokens, not all tokens; hence, this kind of sparse methods are also called local attention mechanism. Swin [22] and Longformer [26] are pioneers in introducing sliding windows into attention computation for vision tasks and language tasks, respectively. To address the information loss introduced by the local windows, Swin introduces a shifted window mechanism to capture cross-block information, while Longformer selects some tokens as global tokens, which have effects on all tokens, to compensate for the global information loss. NesT [35] further simplifies the shifted window mechanism through simple spatial operations. CSWin [23] introduces a cross-shaped window mechanism for 2D sequences. The cross-shaped window mechanism separates a 2D sequence into horizontal and vertical stripes, respectively, and performs parallel attention computation within these stripes in horizontal and vertical directions, which can simultaneously obtain local inductive biases and cross-block (global) information. In addition to using the deterministic global token selection mechanism of Longformer, Big Bird [29] also randomly selects some global tokens to enhance performance. Similarly, the sparse transformer [27] proposed by OpenAI also introduces several fixed-step tokens, which is similar to dilated convolution [36] in convolutional neural networks (CNNs) to capture long-range information. Reformer [30] finds the nearest neighbors for each token to calculate local attention scores using the locality-sensitive-hashing (LSH) algorithm.

### METHODS OF THE PRESENT INVENTION

### A. Vanilla Softmax-Based Attention Mechanism

For clarity, we assume that all vectors appear in the present invention are row vectors. For any two same sized tokens x∈ [symbol] and y∈ [symbol] , their attention similarity score can be calculated as follows,

$$a = exp ( {xy}^{⊤} ) , \qquad ( 1 )$$

where exp(⋅) is an element-wise exponential function and is conducted after the inner product of two tokens. For given two m-tuples {x₁, . . . , xₘ} and {y₁, . . . , yₘ} with xᵢ, yᵢ ∈ [symbol] and i=1, 2, . . . , m, we need to calculate m² pairs of attention similarity scores. Currently, a long sequence length m is preferred in large models and m>>c, therefore, the computational complexity of the vanilla softmax-based attention mechanism is quadratic with respect to the sequence length m.

### B. General Attention Mechanism

Eq. (1) can be rewritten as a more general form [13] as follows,

$$a = sim ( x , y ) , \qquad ( 2 )$$

where sim(⋅) is a non-negative similarity function and it satisfies the definition of a kernel function G(x,y): [symbol] with [symbol] ={x∈ [symbol] x≥0}.

### C. Kernelized Attention Mechanism

If a kernel with a non-negative feature map φ is obtained, Eq. (2) can be written as follows,

$$a = ϕ ( x ) {ϕ ( y )}^{⊤} . \qquad ( 3 )$$

Performer [11] has proved that one of the best choices of the non-negative feature map φ for Eq. (3) is exp(⋅). Performer obtains an exact alternative of Eq. (1) using random feature maps as follows,

$$exp ( x {y}^{⊤} ) = {𝔼}_{ω \sim 𝒩 ( {0}_{c} , {I}_{c} )} [ exp ( ω {x}^{⊤} ) exp ( ω {y}^{⊤} ) e ( x ) e ( y ) ] , \qquad ( 4 )$$

where

$$e ( x ) = exp ( - \frac{{‖ x ‖}^{2}}{2} ) , e ( y ) = exp ( - \frac{{‖ y ‖}^{2}}{2} ) ,$$

0_{c} ∈ [symbol] is the zero vector, and I_{c} ∈ [symbol] is the identity matrix. If the attention scores for all pairs of x and yᵢ (i=1, 2, . . . , m) using Eq. (4) are obtained, after the following normalization e(x) will be canceled.

$$\begin{matrix}\frac{exp ( x {y}_{i}^{⊤} )}{{\sum }_{j = 1}^{m} exp ( x {y}_{j}^{⊤} )} = \frac{{𝔼}_{ω \sim 𝒩 ( {0}_{c} , {I}_{c} )} [ exp ( ω {x}^{⊤} ) exp ( ω {y}_{i}^{⊤} ) e ( x ) e ( {y}_{i} ) ]}{{\sum }_{j = 1}^{m} {𝔼}_{ω \sim 𝒩 ( {0}_{c} , {I}_{c} )} [ exp ( ω {x}^{⊤} ) exp ( ω {y}_{j}^{⊤} ) e ( x ) e ( {y}_{j} ) ]} \\ = \frac{{𝔼}_{ω \sim 𝒩 ( {0}_{c} , {I}_{c} )} [ exp ( ω {x}^{⊤} ) exp ( ω {y}_{i}^{⊤} ) e ( {y}_{i} ) ]}{{\sum }_{j = 1}^{m} {𝔼}_{ω - 𝒩 ( {0}_{c} , {I}_{c} )} [ exp ( ω {x}^{⊤} ) exp ( ω {y}_{j}^{⊤} ) e ( {y}_{j} ) ]}\end{matrix} .$$

Hence, e(x) has no effect on the final attention score. Eq. (4) can be written as follows,

$$exp ( x {y}^{⊤} ) = {𝔼}_{ω \sim 𝒩 ( {0}_{c} , {I}_{c} )} [ exp ( ω {x}^{⊤} ) exp ( ω {y}^{⊤} ) e ( y ) ] . \qquad ( 5 )$$

Eq. (5) only holds when taking the sum of an infinite number of random vectors ω. To avoid performing summation of infinite terms, Performer samples c×log(c) random vectors ω to ensure a low approximation error. If e(y) is much smaller than exp(ωx^{τ})exp(ωy^{τ}), Eq. (5) can be further simplified and approximated as follows,

$$exp ( x {y}^{⊤} ) \approx {𝔼}_{ω - 𝒩 ( {0}_{c} , {I}_{c} )} [ exp ( ω {x}^{⊤} ) exp ( ω {y}^{⊤} ) ] . \qquad ( 6 )$$

Efficient attention (EFFATT) [18] is a special case of Eq. (6). It simplifies ω to a one-hot vector and only uses c one-hot vectors in Eq. (6) to obtain an approximation as follows,

$$exp ( x {y}^{⊤} ) \approx \frac{1}{c} exp ( x ) {exp ( y )}^{⊤} . \qquad ( 7 )$$

Its approximation error was studied and obtained in [5]. Eq. (7) has a problem of concentration reduction of attention maps [5] and Performer also has this problem when the number of ω sampled is too small. When the number of ω sampled is too large, Performer may be slower than the vanilla softmax-based attention mechanism.

### D. Efficient Linear Fast Attention Mechanism

To address the problem of concentration reduction of Eq. (7), in the present invention, a novel attention mechanism is proposed as follows,

$$exp ( Q {K}^{⊤} ) V \approx [ exp ( \overline{Q} ) {exp ( \overline{K} )}^{⊤} \overline{V} , g ( exp ( f ( \tilde{Q} ) {f ( \tilde{K} )}^{⊤} ) ) f ( \tilde{V} ) ] , \qquad ( 8 )$$

where Q=[Q̅,\tilde{Q}] ∈ [symbol] , K=[K̅,\tilde{K}] ∈ [symbol] , V=[V̅,\tilde{V}] ∈ [symbol] , Q̅∈ [symbol] , \tilde{Q}∈ [symbol] , K̅∈ [symbol] , \tilde{K}∈ [symbol] , V̅∈ [symbol] , \tilde{V}∈ [symbol] , c=c₁+c₂, ƒ(⋅) is a blockify function to separate a matrix with a size of m×c₂ into b blocks (each block has a size of (m/b)×c₂), and g(⋅) is an unblockify function to unblock b blocks to a single matrix with a size of m×c₂. Eq. (8) can be derived as follows,

$$\begin{matrix}exp ( Q {K}^{⊤} ) V = ( exp ( {\overline{Q K}}^{⊤} ) ⊙ exp ( \tilde{Q} {\tilde{K}}^{⊤} ) ) V \\ = exp ( {\overline{Q K}}^{⊤} ) ⊙ exp ( \tilde{Q} {\tilde{K}}^{⊤} ) [ \overline{V} , \tilde{V} ] \\ = [ ( exp ( {\overline{Q K}}^{⊤} ) ⊙ exp ( \tilde{Q} {\tilde{K}}^{⊤} ) ) \overline{V} , ( exp ( {\overline{Q K}}^{⊤} ) ⊙ exp ( \tilde{Q} {\tilde{K}}^{⊤} ) ) \tilde{V} ] \\ \approx [ exp ( {\overline{Q K}}^{⊤} ) \overline{V} , exp ( \tilde{Q} {\tilde{K}}^{⊤} ) \tilde{V} ] \\ \approx [ exp ( \overline{Q} ) {exp ( \overline{K} )}^{⊤} \overline{V} , ( exp ( \tilde{Q} {\tilde{K}}^{⊤} ) ⊙ Z ) \tilde{V} ]\end{matrix}$$

where ⊙ denotes the Hadamard product [37], exp(\tilde{Q}\tilde{K}^{τ})⊙ Z\tilde{V} is equivalent to g(exp(ƒ(\tilde{Q})ƒ(\tilde{K})^{τ})ƒ(\tilde{V})), and Z∈ [symbol] is a matrix as follows,

$$Z = {I}_{b} ⊗ {U}_{( m / b )} ,$$

with ⊗ denoting the Kronecker product [37] and U_{(m/b)} ∈ [symbol] being the all-ones matrix. It is obvious to see that

$$[ exp ( \overline{Q} ) {exp ( \overline{K} )}^{T} \overline{V} , ( exp ( \tilde{Q} {\tilde{K}}^{T} ) ⊙ Z ) \tilde{V} ] - exp ( {QK}^{T} ) V = [ ( exp ( \overline{Q} ) {exp ( \overline{K} )}^{T} - exp ( \overline{Q} {\overline{K}}^{T} ) ⊙ exp ( \tilde{Q} {\tilde{K}}^{T} ) \overline{V} ,$$

$$( exp ( \tilde{Q} {\tilde{K}}^{T} ) ⊙ Z - exp ( \overline{Q} {\overline{K}}^{T} ) ⊙ exp ( \tilde{Q} {\tilde{K}}^{T} ) ) \tilde{V} ] ,$$

which implies that

$${‖ [ exp ( \overline{Q} ) {exp ( \overline{K} )}^{T} \overline{V} , ( exp ( \tilde{Q} {\tilde{K}}^{T} ) ⊙ Z ) \tilde{V} ] - exp ( {QK}^{T} ) V ‖}_{ξ} \leq {‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} {‖ \overline{V} ‖}_{ξ} + {‖ exp ( \tilde{Q} {\tilde{K}}^{T} ) ⊙ Z - exp ( \overline{Q} {\overline{K}}^{T} ) ⊙ exp ( \tilde{Q} {\tilde{K}}^{T} ) ‖}_{ξ} {‖ \tilde{V} ‖}_{ξ} , \qquad ( 9 )$$

where ξ=2 denotes the spectral norm and ξ=F denotes the Frobenius norm. For given two matrices A∈ [symbol] and B∈ [symbol] , it follows from [38, Section 2.3.1] that ∥AB∥_{ξ}≤∥A∥_{ξ}∥B∥_{ξ}.

For the second term in the right-hand side of Inequality (9), it is easy to see that

$${‖ exp ( \tilde{Q} {\tilde{K}}^{T} ) ⊙ Z - exp ( \overline{Q} {\overline{K}}^{T} ) ⊙ exp ( \tilde{Q} {\tilde{K}}^{T} ) ‖}_{ξ} {‖ \tilde{V} ‖}_{ξ} \leq {‖ Z - exp ( \overline{Q} {\overline{K}}^{T} ) ‖}_{ξ} {‖ exp ( \tilde{Q} {\tilde{K}}^{T} ) ‖}_{ξ} {‖ \tilde{V} ‖}_{ξ} .$$

For the first term in the right-hand side of Inequality (9), it can be observed from the following theorem.

Theorem 1. Let Uₘ∈ [symbol] be an all-ones matrix. For any two vectors q∈ [symbol] from Q∈ [symbol] and k∈ [symbol] from K∈ [symbol] , let [symbol] >0 and [symbol] >0 be the maximum and minimum of exp(qk^{τ}+0.5−(qᵢ+kᵢ)), respectively, and qᵢ and kᵢ are the elements at position i of vectors q and k, respectively. If

$$\vert \frac{c}{ℳexp ( - 0.5 )} - 1 \vert \geq \vert \frac{c}{𝔐exp ( - 0.5 )} - 1 \vert ,$$

the following inequality holds,

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} \leq \frac{c}{ℳexp ( - 0.5 )} {‖ exp ( \overline{Q} {\overline{K}}^{T} ) ‖}_{ξ} {‖ {U}_{m} - exp ( \tilde{Q} {\tilde{K}}^{T} ) ‖}_{ξ} + \vert \frac{c}{ℳexp ( - 0.5 )} - 1 \vert {‖ exp ( \overline{Q} {\overline{K}}^{T} ) ‖}_{ξ} {‖ exp ( \tilde{Q} {\tilde{K}}^{T} ) ‖}_{ξ} .$$

If

$$\vert \frac{c}{ℳexp ( - 0.5 )} - 1 \vert < \vert \frac{c}{𝔐exp ( - 0.5 )} - 1 \vert ,$$

the following inequality holds,

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} \leq \frac{c}{ℳexp ( - 0.5 )} {‖ exp ( \overline{Q} {\overline{K}}^{T} ) ‖}_{ξ} {‖ {U}_{m} - exp ( \tilde{Q} {\tilde{K}}^{T} ) ‖}_{ξ} + \vert \frac{c}{𝔐exp ( - 0.5 )} - 1 \vert {‖ exp ( \overline{Q} {\overline{K}}^{T} ) ‖}_{ξ} {‖ exp ( \tilde{Q} {\tilde{K}}^{T} ) ‖}_{ξ} .$$

Before proving Theorem 1, the following lemma (see [5]) is introduced.

Lemma 1. For any two vectors q∈ [symbol] from Q∈ [symbol] and k∈ [symbol] from K∈ [symbol] , let

$${D}_{q , k} = {max}_{i = 1 , 2 , ... , c} exp ( {qk}^{T} + 0.5 - ( {q}_{i} + {k}_{i} ) ) > 0 ,$$

$${d}_{q , k} = {min}_{i = 1 , 2 , ... , c} exp ( {qk}^{T} + 0.5 - ( {q}_{i} + {k}_{i} ) ) > 0 ,$$

where qᵢ and kᵢ are the elements at position i of vectors q and k, respectively. The following inequalities hold,

$$\frac{exp ( q ) {exp ( k )}^{T}}{exp ( {qk}^{T} )} \leq \frac{c}{{d}_{q , k} exp ( - 0.5 )}$$

$$\frac{exp ( q ) {exp ( k )}^{T}}{exp ( {qk}^{T} )} \geq \frac{c}{{D}_{q , k} exp ( - 0.5 )}$$

The following corollary is easily obtained from Lemma 1.

Corollary 1. For two matrices Q∈ [symbol] and K∈ [symbol] , let

$$𝔐 = {{max}_{{i}_{1} , {i}_{2} = 1 , 2 , ... , m}}_{j = 1 , 2 , ... , c} exp ( {q}_{{i}_{1}} {k}_{{i}_{2}}^{T} + 0.5 - ( {q}_{{i}_{1} j} + {k}_{{i}_{2} j} ) ) > 0 ,$$

$$ℳ = {{min}_{{i}_{1} , {i}_{2} = 1 , 2 , ... , m}}_{j = 1 , 2 , ... , c} exp ( {q}_{{i}_{1}} {k}_{{i}_{2}}^{T} + 0.5 - ( {q}_{{i}_{1} j} + {k}_{{i}_{2} j} ) ) > 0 ,$$

where qᵢ_{₁}ⱼ and kᵢ_{₂}ⱼ are the elements at position j of the vector qᵢ_{₁}=Q(i₁,:) and the vector kᵢ_{₂}=K(i₂,:), respectively. The following inequalities hold,

$$\frac{{‖ exp ( Q ) {exp ( K )}^{T} ‖}_{ξ}}{{‖ exp ( {QK}^{T} ) ‖}_{ξ}} \leq \frac{c}{ℳexp ( - 0.5 )}$$

$$\frac{{‖ exp ( Q ) {exp ( K )}^{T} ‖}_{ξ}}{{‖ exp ( {QK}^{T} ) ‖}_{ξ}} \geq \frac{c}{𝔐exp ( - 0.5 )}$$

Proof. For any matrices Q̅∈ [symbol] , \tilde{Q}∈ [symbol] , K̅∈ [symbol] , \tilde{K}∈ [symbol] , we have

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} = {‖ exp ( \overline{Q} ) {exp ( \overline{K} )}^{T} - exp ( \overline{Q} ) {exp ( \overline{K} )}^{T} ⊙ exp ( \tilde{Q} {\tilde{K}}^{T} ) + exp ( \overline{Q} ) {exp ( \overline{K} )}^{T} ⊙ exp ( \tilde{Q} {\tilde{K}}^{T} ) - exp ( \overline{Q} {\overline{K}}^{T} ) ⊙ exp ( \tilde{Q} {\tilde{K}}^{T} ) ‖}_{ξ} \leq {‖ exp ( \overline{Q} ) {exp ( \overline{K} )}^{T} - exp ( \overline{Q} ) {exp ( \overline{K} )}^{T} ⊙ exp ( \tilde{Q} {\tilde{K}}^{T} ) ‖}_{ξ} + {‖ exp ( \overline{Q} ) {exp ( \overline{K} )}^{T} ⊙ exp ( \tilde{Q} {\tilde{K}}^{T} ) - exp ( \overline{Q} {\overline{K}}^{T} ) ⊙ exp ( \tilde{Q} {\tilde{K}}^{T} ) ‖}_{ξ} \leq {‖ exp ( \overline{Q} ) {exp ( \overline{K} )}^{T} ‖}_{ξ} {‖ {U}_{m} - exp ( \tilde{Q} {\tilde{K}}^{T} ) ‖}_{ξ} + {‖ exp ( \overline{Q} ) {exp ( \overline{K} )}^{T} - exp ( \overline{Q} {\overline{K}}^{T} ) ‖}_{ξ} {‖ exp ( \tilde{Q} {\tilde{K}}^{T} ) ‖}_{ξ} .$$

Following from Corollary 1, if

$$\vert \frac{c}{ℳexp ( - 0.5 )} - 1 \vert \geq \vert \frac{c}{𝔐exp ( - 0.5 )} - 1 \vert ,$$

we have

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} \leq \frac{c}{ℳexp ( - 0.5 )} {‖ exp ( \overline{Q} {\overline{K}}^{T} ) ‖}_{ξ} {‖ {U}_{m} - exp ( \tilde{Q} {\tilde{K}}^{T} ) ‖}_{ξ} + \vert \frac{c}{ℳexp ( - 0.5 )} - 1 \vert {‖ exp ( \overline{Q} {\overline{K}}^{T} ) ‖}_{ξ} {‖ exp ( \tilde{Q} {\tilde{K}}^{T} ) ‖}_{ξ} .$$

If

$$\vert \frac{c}{ℳexp ( - 0.5 )} - 1 \vert < \vert \frac{c}{𝔐exp ( - 0.5 )} - 1 \vert ,$$

one has

$${{‖ exp ( \overline{Q} ) exp ( \overline{K} ) ‖}^{T} - exp ( \overline{Q} {\overline{K}}^{T} ) ⊙ exp ( \tilde{Q} {\tilde{K}}^{T} ) ‖}_{ξ} \leq \frac{c}{ℳexp ( - 0.5 )} {‖ exp ( \overline{Q} {\overline{K}}^{T} ) ‖}_{ξ} {‖ {U}_{m} - exp ( \tilde{Q} {\tilde{K}}^{T} ) ‖}_{ξ} + \vert \frac{c}{𝔐exp ( - 0.5 )} - 1 \vert {‖ exp ( \overline{Q} {\overline{K}}^{T} ) ‖}_{ξ} {‖ exp ( \tilde{Q} {\tilde{K}}^{T} ) ‖}_{ξ} .$$

The proof is completed.

The upper bound for the right-hand side of Eq. (9) is now considered. If

$$\vert \frac{c}{ℳexp ( - 0.5 )} - 1 \vert \geq \vert \frac{c}{𝔐exp ( - 0.5 )} - 1 \vert ,$$

the total approximation error is bounded as follows,

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} {‖ \overline{V} ‖}_{ξ} + {‖ exp ( \tilde{Q} {\tilde{K}}^{T} ) ⊙ Z - exp ( \overline{Q} {\overline{K}}^{T} ) ⊙ exp ( \tilde{Q} {\tilde{K}}^{T} ) ‖}_{ξ} {‖ \overline{V} ‖}_{ξ} \leq ( \frac{c}{ℳexp ( - 0.5 )} {‖ {U}_{m} - exp ( \tilde{Q} {\tilde{K}}^{T} ) ‖}_{ξ} + \vert \frac{c}{ℳexp ( - 0.5 )} - 1 \vert {‖ exp ( \tilde{Q} {\tilde{K}}^{T} ) ‖}_{ξ} ) {‖ exp ( \overline{Q} {\overline{K}}^{T} ) ‖}_{ξ} {‖ \overline{V} ‖}_{ξ} + {‖ Z - exp ( \overline{Q} {\overline{K}}^{T} ) ‖}_{ξ} {‖ exp ( \tilde{Q} {\tilde{K}}^{T} ) ‖}_{ξ} {‖ \overline{V} ‖}_{ξ} . \qquad ( 10 )$$

If

$$\vert \frac{c}{ℳexp ( - 0.5 )} - 1 \vert < \vert \frac{c}{𝔐exp ( - 0.5 )} - 1 \vert ,$$

the total approximation error is bounded as follows,

$${‖ exp ( \overline{Q} ) {exp ( \overline{K} )}^{T} - exp ( \overline{Q} {\overline{K}}^{T} ) ⊙ exp ( \tilde{Q} {\tilde{K}}^{T} ) ‖}_{ξ} {‖ \overline{V} ‖}_{ξ} + {‖ exp ( \tilde{Q} {\tilde{K}}^{T} ) ⊙ Z - exp ( \overline{Q} {\overline{K}}^{T} ) ⊙ exp ( \tilde{Q} {\tilde{K}}^{T} ) ‖}_{ξ} {‖ \overline{V} ‖}_{ξ} \leq ( \frac{c}{ℳexp ( - 0.5 )} {‖ {U}_{m} - exp ( \tilde{Q} {\tilde{K}}^{T} ) ‖}_{ξ} + \vert \frac{c}{𝔐exp ( - 0.5 )} - 1 \vert {‖ exp ( \tilde{Q} {\tilde{K}}^{T} ) ‖}_{ξ} ) {‖ exp ( \overline{Q} {\overline{K}}^{T} ) ‖}_{ξ} {‖ \overline{V} ‖}_{ξ} + {‖ Z - exp ( \overline{Q} {\overline{K}}^{T} ) ‖}_{ξ} {‖ exp ( \tilde{Q} {\tilde{K}}^{T} ) ‖}_{ξ} {‖ \overline{V} ‖}_{ξ} . \qquad ( 11 )$$

Eq. (8) denotes the single-head vanilla softmax-based attention mechanism approximated by using ELFATT, and Inequality (9) denotes the corresponding approximation error. From the right-hand side of Eq. (8), each ELFATT attention process consists of two heads. Hence, ELFATT can directly become an approximation of the double-head vanilla softmax-based attention mechanism as follows,

$$[ exp ( \overline{Q} {\overline{K}}^{T} ) \overline{V} , exp ( \tilde{Q} {\tilde{K}}^{T} ) \tilde{V} ] \approx [ exp ( \overline{Q} ) {exp ( \overline{K} )}^{T} \overline{V} , g ( exp ( f ( \tilde{Q} ) {f ( \tilde{K} )}^{T} ) f ( \tilde{V} ) ) ] . \qquad ( 12 )$$

It is obvious to see that

$$[ exp ( \overline{Q} ) {exp ( \overline{K} )}^{T} \overline{V} , ( exp ( \tilde{Q} {\tilde{K}}^{T} ) ⊙ Z ) \tilde{V} ] - [ exp ( \overline{Q} {\overline{K}}^{T} ) \overline{V} ,$$

$$exp ( \tilde{Q} {\tilde{K}}^{T} ) \tilde{V} ] = [ ( exp ( \overline{Q} ) {exp ( \overline{K} )}^{T} - exp ( \overline{Q} {\overline{K}}^{T} ) ) \overline{V} ,$$

$$( exp ( \tilde{Q} {\tilde{K}}^{T} ) ⊙ Z - exp ( \tilde{Q} {\tilde{K}}^{T} ) ) \tilde{V} ] .$$

Hence, the corresponding approximation error is bounded as follows,

$${‖ [ exp ( \overline{Q} ) {exp ( \overline{K} )}^{T} \overline{V} , ( exp ( \tilde{Q} {\tilde{K}}^{T} ) ⊙ Z ) \tilde{V} ] - [ exp ( \overline{Q} {\overline{K}}^{T} ) \overline{V} , exp ( \tilde{Q} {\tilde{K}}^{T} ) \tilde{V} ] ‖}_{ξ} \leq {‖ exp ( \overline{Q} ) {exp ( \overline{K} )}^{T} - exp ( \overline{Q} {\overline{K}}^{T} ) ‖}_{ξ} {‖ \overline{V} ‖}_{ξ} + {‖ exp ( \tilde{Q} {\tilde{K}}^{T} ) ⊙ Z - exp ( \tilde{Q} {\tilde{K}}^{T} ) ‖}_{ξ} {‖ \overline{V} ‖}_{ξ} . \qquad ( 13 )$$

If

$$\vert \frac{c}{ℳexp ( - 0.5 )} - 1 \vert \geq \vert \frac{c}{𝔐exp ( - 0.5 )} - 1 \vert ,$$

one has

$${‖ [ exp ( \overline{Q} ) {exp ( \overline{K} )}^{T} \overline{V} , ( exp ( \tilde{Q} {\tilde{K}}^{T} ) ⊙ Z ) \tilde{V} ] - [ exp ( \overline{Q} {\overline{K}}^{T} ) \overline{V} , exp ( \tilde{Q} {\tilde{K}}^{T} ) \tilde{V} ] ‖}_{ξ} \leq \vert \frac{c}{ℳexp ( - 0.5 )} - 1 \vert {‖ exp ( \overline{Q} {\overline{K}}^{T} ) ‖}_{ξ} {‖ \overline{V} ‖}_{ξ} + {‖ Z - {U}_{m} ‖}_{ξ} {‖ exp ( \tilde{Q} {\tilde{K}}^{T} ) ‖}_{ξ} {‖ \tilde{V} ‖}_{ξ} . \qquad ( 14 )$$

If

$$\vert \frac{c}{ℳexp ( - 0.5 )} - 1 \vert < \vert \frac{c}{𝔐exp ( - 0.5 )} - 1 \vert ,$$

one has

$${‖ [ exp ( \overline{Q} ) {exp ( \overline{K} )}^{T} \overline{V} , ( exp ( \tilde{Q} {\tilde{K}}^{T} ) ⊙ Z ) \tilde{V} ] - [ exp ( \overline{Q} {\overline{K}}^{T} ) \overline{V} , exp ( \tilde{Q} {\tilde{K}}^{T} ) \tilde{V} ] ‖}_{ξ} \leq \vert \frac{c}{𝔐exp ( - 0.5 )} - 1 \vert {‖ exp ( \overline{Q} {\overline{K}}^{T} ) ‖}_{ξ} {‖ \overline{V} ‖}_{ξ} + {‖ Z - {U}_{m} ‖}_{ξ} {‖ exp ( \tilde{Q} {\tilde{K}}^{T} ) ‖}_{ξ} {‖ \tilde{V} ‖}_{ξ} . \qquad ( 15 )$$

Inequalities (13-15) give a tighter bound than Inequalities (9-11).

Since each ELFATT attention process corresponds to two parallel heads, s ELFATT will be needed for the approximation of 2×s heads of vanilla softmax-based attention according to Eq. (12). For the approximation of 2×s+1 heads of vanilla softmax-based attention, 2×s+1 ELFATT will be needed according to Eq. (8).

### E. Positional Encoding

Different positional encoding mechanisms such as absolute positional encoding [39], relative positional encoding [40], and conditional positional encoding [41], have been proposed to make use of the ordering information of sequences in vision transformers [23], [39], [41]. Among these positional encoding mechanisms, the locally enhanced positional encoding (LePE) [23] mechanism shows more powerful local positional information enhancement and brings a higher performance gain for vision transformers. Hence, LePE is selected as the positional encoding mechanism for ELFATT. After introducing LePE, Eq. (8) will become as follows,

$$exp ( {QK}^{T} ) V + L ( V ) \approx [ exp ( \overline{Q} ) {exp ( \overline{K} )}^{T} \overline{V} + L ( V ) , g ( exp ( f ( \tilde{Q} ) {f ( \tilde{K} )}^{T} ) f ( \tilde{V} ) + L ( f ( \tilde{V} ) ) ) ] , \qquad ( 16 )$$

Eq. (12) will become as follows,

$$[ exp ( \overline{Q} {\overline{K}}^{T} ) \overline{V} + L ( \overline{V} ) , exp ( \tilde{Q} {\tilde{K}}^{T} ) \tilde{V} + L ( \tilde{V} ) ] \approx [ exp ( \overline{Q} ) {exp ( \overline{K} )}^{T} \overline{V} + L ( \overline{V} ) , g ( exp ( f ( \tilde{Q} ) {f ( \tilde{K} )}^{T} ) f ( \tilde{V} ) + L ( f ( \tilde{V} ) ) ) ] , \qquad ( 17 )$$

where L(⋅) denotes a depthwise convolution operation with a kernel size of 3.

### F. Complexity Analysis

According to Eqs. (16) and (17), the complexity of ELFATT can be divided into two parts: (a) the global linear attention head exp(Q̅)exp(K̅)^{τ}V̅+L(V̅); (b) the local blockify attention head g(exp(ƒ(\tilde{Q})ƒ(\tilde{K})^{τ})ƒ(\tilde{V})+L(ƒ(\tilde{V}))). The complexity of the global linear attention

### IV. EXPERIMENTS AND RESULTS

ELFATT is evaluated in commonly used vision tasks: image classification (ImageNet-1K [42]), semantic segmentation (ADE20K [43]), and object detection (MS COCO 2017 [44]). ELFATT is compared with the vanilla softmax-based attention mechanism [39], the memory-efficient attention mechanism (FlashAttention-2 [7]), local window-based attention mechanisms (Swin [22] and CSWin [23]), and kernel-based attention mechanisms (Agent [19], EFFATT [18], and FLatten [10]). The backbone ViT architectures used to evaluate the different attention mechanisms are: Swin-T [22], CSWin-T24181 [10], and CSWin-B36292 [10]. The original Swin-T, CSWin-T24181, and CSWin-B36292 are called Swin-T-LOCAL, CSWin-T24181-LOCAL, and CSWin-B36292-LOCAL, respectively. The backbones after replacing local window-based attention mechanisms with the vanilla softmax-based attention mechanism [39] are called Swin-T-GLOBAL, CSWin-T24181-GLOBAL, and CSWin-B36292-GLOBAL, respectively. The backbones after replacing local window-based attention mechanisms with kernel-based attention mechanisms (Agent [19], EFFATT [18], and FLatten [10]) are called Swin-T-Agent, Swin-T-EFFATT, Swin-T-FLatten, CSWin-T24181-Agent, CSWin-T24181EFFATT, CSWin-T24181-FLatten, CSWin-B36292-Agent, CSWin-B36292-EFFATT, and CSWin-B36292-FLatten, respectively. The backbones after replacing local window-based attention mechanisms with ELFATT are called Swin-T-ELFATT, CSWin-T24181-ELFATT, and CSWin-B36292-ELFATT, respectively. For the ImageNet-1K image classification task, we used the same training settings and data augmentation methods from [23] to train all models from scratch using mixed precision. For the ADE20K semantic segmentation task [43] and the MS COCO 2017 object detection task [44], we used the same training settings and data augmentation methods from [45] to fine-tune the weights of all models obtained from the ImageNet-1K image classification task using mixed precision. We also compared ELFATT with ConvNeXt-T [46] and VMamba-T [45] on ImageNet-1K, ADE20K, and MS COCO 2017. The experiments of ImageNet-1K, ADE20K, and MS COCO 2017 were carried out on 8 NVIDIA vGPU (32 GB) GPUs. Inference throughput comparison experiments were carried out on 1 NVIDIA H20 (96 GB) GPU. We used FashAttention-2 [7] to speed up all models that are compatible with FlashAttention. The PyTorch implementation of ELFATT is available at [https://github.com/Alicewithrabbit/ELFATT]. The training scripts are available in the official repositories of CSWin [https://github.com/microsoft/CSWin-Transformer] for ImageNet-1K and VMamba [https://github.com/MzeroMiko/VMamba] for ADE20K and MS COCO 2017.

### A. Image Classification Performance

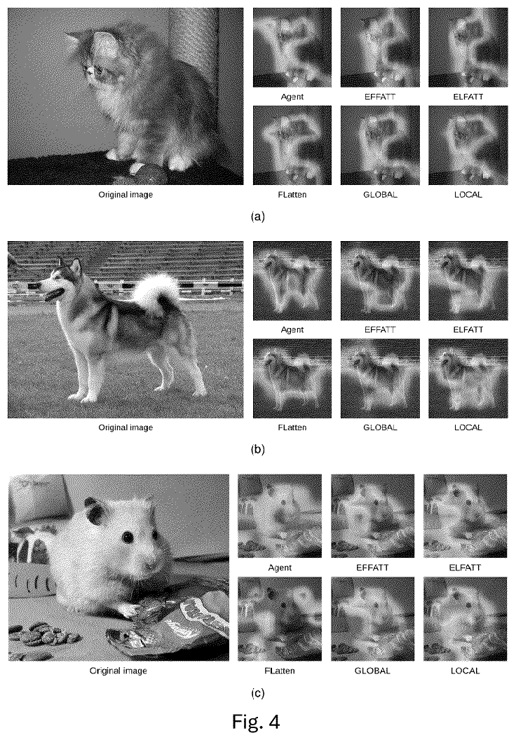

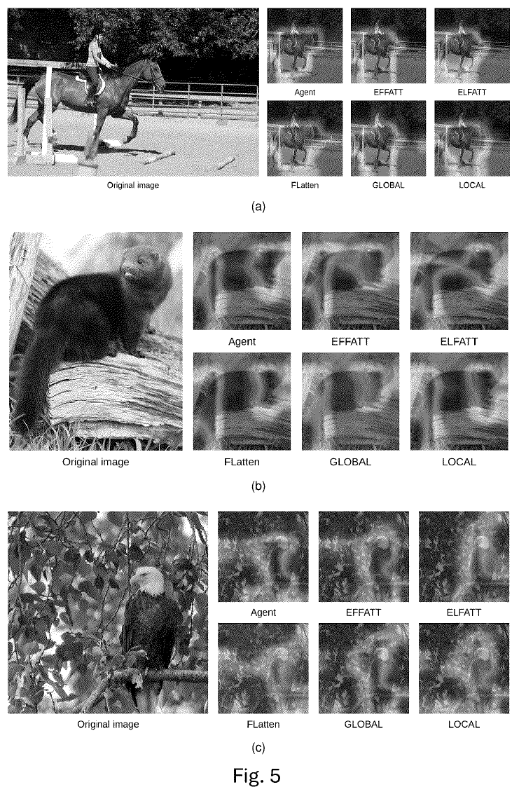

Table I shows the performance comparison of different attention mechanisms on ImageNet-1K. From Table I, the vanilla softmax-based attention mechanism (Swin-T-GLOBAL and CSWin-T24181-GLOBAL) can outperform most linear attention mechanisms using the same architecture. Only Agent and ELFATT achieve the most close performance compared to the vanilla softmax-based attention mechanism in this paper. As to the inference speed comparison, the proposed ELFATT achieves the highest inference throughput (frame per second, FPS) than all other attention mechanisms when using CSWin-T24181 as the backbone. ELFATT achieves almost the same speed as EFFATT and is significantly faster than other attention mechanisms when using Swin-T as the backbone. ELFATT offers almost a 2× speedup over the vanilla softmax-based attention mechanism without using FlashAttention-2. The vanilla softmax-based attention mechanism using FlashAttention-2 is still 0.1-0.2× slower than ELFATT without using FlashAttention-2. With the use of FlashAttention-2 to optimize memory operations, ELFATT can be further accelerated and offers 1.2-1.3× speedups over the vanilla softmax-based attention mechanism. FIGS. 4-5 show the visual comparison of different attention mechanisms using CSWin-T24181 as the backbone. ELFATT shows a much closer attention map to the vanilla softmax-based attention mechanism than other attention mechanisms. For the larger backbone, CSWin-B36292, ELFATT still achieves state-of-the-art (SOTA) performance. ELFATT offers a 2.1/1.4× speedup over the vanilla softmax-based attention mechanism with/without using FlashAttention-2.

TABLE I

| | | Acc. | | | | FLOPs |
|---|---|---|---|---|---|---|
| Method | Res. | (%) | FPS (nFA/FA) | | # | (nFA/FA) |
| CSWin-B36292-Agent | 224² | 84.7 | 930/994 | imgs/s | 73 M | 14.92 G/14.49 G |
| CSWin-B36292-EFFATT | 224² | 84.4 | 985/1059 | imgs/s | 73 M | 14.98 G/14.53 G |
| CSWin-B36292-ELFATT | 224² | 84.7 | 1000/1187 | imgs/s | 73 M | 15.47 G/14.46 G |
| CSWin-B36292-FLatten | 224² | 84.5 | 814/864 | imgs/s | 75 M | 14.96 G/14.52 G |
| CSWin-B36292-GLOBAL | 224² | 84.7 | 478/879 | imgs/s | 73 M | 22.33 G/14.39 G |
| CSWin-B36292-LOCAL | 224² | 84.4 | 941/1037 | imgs/s | 73 M | 15.03 G/14.39 G |
| CSWin-T24181-Agent | 224² | 83.1 | 2297/2425 | imgs/s | 20 M | 4.31 G/4.14 G |
| CSWin-T24181-EFFATT | 224² | 82.6 | 2394/2526 | imgs/s | 20 M | 4.35 G/4.17 G |
| CSWin-T24181-ELFATT | 224² | 83.1 | 2603/2856 | imgs/s | 20 M | 4.44 G/4.13 G |
| CSWin-T24181-FLatten | 224² | 83.1 | 1934/2025 | imgs/s | 21 M | 4.34 G/4.16 G |
| CSWin-T24181-GLOBAL | 224² | 83.1 | 1303/2210 | imgs/s | 20 M | 7.60 G/4.09 G |
| CSWin-T24181-LOCAL | 224² | 82.7 | 2330/2519 | imgs/s | 20 M | 4.36 G/4.09 G |
| Swin-T-Agent | 224² | 82.6 | 2847/— | imgs/s | 29 M | 4.53 G/— |
| Swin-T-EFFATT | 224² | 82.1 | 3165/3282 | imgs/s | 28 M | 4.55 G/4.45 G |
| Swin-T-ELFATT | 224² | 82.7 | 2884/3159 | imgs/s | 30 M | 4.99 G/4.67 G |
| Swin-T-FLatten | 224² | 82.1 | 2502/— | imgs/s | 29 M | 4.50 G/— |
| Swin-T-GLOBAL | 224² | 82.4 | 1269/2571 | imgs/s | 28 M | 8.81 G/4.38 G |
| Swin-T-LOCAL | 224² | 81.4 | 2943/— | mgs/s | 28 M | 4.51 G/— |
| ConvNeXt-T | 224² | 82.1 | 3911/— | imgs/s | 29 M | 4.47 G/— |
| VMamba-T | 224² | 82.5 | 1837/— | imgs/s | 30 M | 4.84 G/— |

The comparison of top-1 test accuracy (Acc.), inference throughput (FPS), parameter numbers (#), and number of floating point operations (FLOPs) of different attention mechanisms on ImageNet-1K. Note: Inference throughput of tiny models is obtained using a batch size of 512 with mixed precision on a single NVIDIA H20 (96 GB) GPU and inference throughput of base models is obtained using a batch size of 256 with mixed precision on a single NVIDIA H20 (96 GB) GPU. “-” denotes the corresponding method cannot be accelerated by FlashAttention-2. “Res.” denotes resolution, “imgs” denotes images, “nFA” denotes non-FlashAttention-2 acceleration, and “FA” denotes FlashAttention-2 acceleration.

### B. Ablation Study of Block Size

To validate the effect of the block size on the performance of ELFATT, we performed an ablation study using different block sizes at each level of CSWin-T24181-ELFATT on ImageNet-IK. As shown in Table II, with the increasing number of block sizes, the inference speed of ELFATT will slow down, while the classification accuracy of ELFATT shows an increasing trend. ELFATT using 49-49-196-49 and 196-196-196-49 blocks achieve the best performance in terms of speed and accuracy. It seems that FlashAttention-2 acceleration is more efficient for some block sizes (with FlashAttention-2 acceleration, the block size of 196 is faster than the block size of 49 which may be caused by GPU architectures). Hence, the block sizes for ELFATT can be determined according to the performance and efficiency requirements.

TABLE II

| Block size of each level | | | | | | | | |
|---|---|---|---|---|---|---|---|---|
| Level 1 | Level 2 | Level 3 | Level 4 | Res. | Acc. | FPS (nFA/FA) | # | FLOPs (nFA/FA) |
| 49 | 49 | 49 | 49 | 224² | 82.5 | 2619/2805 imgs/s | 20M | 4.37 G/4.13 G |
| 49 | 49 | 196 | 49 | 224² | 83.1 | 2603/2856 imgs/s | 20M | 4.44 G/4.13 G |
| 49 | 196 | 196 | 49 | 224² | 82.8 | 2552/2863 imgs/s | 20M | 4.50 G/4.13 G |
| 196 | 196 | 196 | 49 | 224² | 83.1 | 2512/2881 imgs/s | 20M | 4.56 G/4.13 G |

The comparison of top-1 test accuracy (Acc.), inference throughput (FPS), parameter numbers (#), and number of floating point operations (FLOPs) of ELFATT using different block sizes in each level of CSWin-T24181 on ImageNet-1K. Note: Inference throughput is obtained using a batch size of 512 with mixed precision on a single NVIDIA H20 (96 GB) GPU. The best values are in bold. “Res.” denotes resolution, “imgs” denotes images, “nFA” denotes non-FlashAttention-2 acceleration, and “FA” denotes FlashAttention-2 acceleration.

### C. Ablation Study of LePE

To validate the effect of LePE on performance, we compared the performance of ELFATT and the vanilla softmax-based attention mechanism using or without using LePE in CSWin-T24181 on ImageNet-1K. As shown in Table III, using LePE, the performance of the vanilla softmax-based attention mechanism improves from 82.9 to 83.1 and the performance of ELFATT also improves from 82.9 to 83.1, respectively, further demonstrating the powerful local positional information enhancement of LePE. More details about LePE can be found in [23].

TABLE III

| | | Acc. | | | | FLOPs |
|---|---|---|---|---|---|---|
| Method | Res. | (%) | FPS (nFA/FA) | | # | (nFA/FA) |
| CSWin-T24181-ELFATT | 224² | 83.1 | 2512/2881 | imgs/s | 20 M | 4.56 G/4.13 G |
| CSWin-T24181-ELFATT- | 224² | 82.9 | 2801/3271 | imgs/s | 20 M | 4.54 G/4.12 G |
| w/o-LePE | | | | | | |
| CSWin-T24181-GLOBAL | 224² | 83.1 | 1303/2210 | imgs/s | 20 M | 7.60 G/4.09 G |
| CSWin-T24181-GLOBAL- | 224² | 82.9 | 1332/2296 | imgs/s | 20 M | 7.58 G/4.08 G |
| w/o-LePE | | | | | | |

The comparison of top-1 test accuracy (Acc.), inference throughput (FPS), parameter numbers (#), and number of floating point operations (FLOPs) of ELFATT and the vanilla softmax-based attention mechanism using or without using LePE in CSWin-T24181 on ImageNet-1K. Note: Inference throughput is obtained using a batch size of 512 with mixed precision on a single NVIDIA H20 (96 GB) GPU. The best values are in bold. “Res.” denotes resolution, “imgs” denotes images, “w/o” denotes “without”, “nFA” denotes non-FlashAttention-2 acceleration, and “FA” denotes FlashAttention-2 acceleration.

### D. Ablation Study of Number of Levels Using the ELFATT Module

To validate the effect of the number of ELFATT modules used to replace the vanilla softmax-based attention (VaniATT) modules at different levels of vision transformers, we compared the performance of CSWin-T24181 using a different number of ELFATT modules at different levels. As shown in Table IV, with the number of levels using ELFATT modules increasing, the inference speed increases without using FlashAttention-2 acceleration. The difference between CSWin-T24181 using 3 levels of ELFATT modules and 4 levels of ELFATT modules is not significant. The fourth level of CSWin-T24181 is composed of only one module and the sequence length is only 49 which is too short to achieve a significant acceleration effect. Another thing that can be found in Table IV is that with an increase in the number of levels using ELFATT modules, CSWin-T24181 using FlashAttention-2 acceleration achieves the fastest inference speed when using two levels of ELFATT modules. Because the sequence lengths of the first two levels are 3136 and 784, respectively, which are significantly longer than the last two levels (the 3^{rd} level: 196, and the 4^{th} level: 49). That is also the reason why some efficient attention mechanisms, such as Agent and FLatten, only replace some of levels by their efficient attention modules. We also observed that with an increasing number of levels using ELFATT modules, the performance shows a gradual decline. To address this defect, we introduced a hybrid architecture in the third level which replaces half of the ELFATT modules at this level by vanilla softmax-based attention modules. The order of composition is as follows: VaniATT-ELFATT- . . . -VaniATT-ELFATT. The reason is that the third level of the vision transformer is usually much deeper than other levels and the sequence of this level is also much shorter than the first two levels. VaniATT at this level will not affect the speed too much and can help the model to converge faster. Swin-T-ELFATT and CSWin-B36292-ELFATT also use a pure ELFATT architecture in the first two levels and a hybrid architecture in the third level. All variants of CSWin-T24181 using ELFATT modules to replace VaniATT modules are faster than CSWin-T24181-GLOBAL of which all levels are composed of VaniATT modules.

TABLE IV

| Levels with using the ELFATT module | | | | | | | | |
|---|---|---|---|---|---|---|---|---|
| Level 1 | Level 2 | Level 3 | Level 4 | Res. | Acc. | FPS (nFA/FA) | # | FLOPs (nFA/FA) |
| ✓ | | | | 224² | 83.0 | 2257/2865 imgs/s | 20M | 5.17 G/4.10 G |
| ✓ | ✓ | | | 224² | 83.0 | 2467/2918 imgs/s | 20M | 4.63 G/4.12 G |
| ✓ | ✓ | ✓ | | 224² | 82.6 | 2555/2842 imgs/s | 20M | 4.48 G/4.15 G |
| ✓ | ✓ | ✓ | | 224² | 83.1 | 2512/2881 imgs/s | 20M | 4.56 G/4.13 G |
| ✓ | ✓ | ✓ | ✓ | 224² | 82.6 | 2552/2835 imgs/s | 20M | 4.48 G/4.15 G |

| | | | | | |
|---|---|---|---|---|---|
| CSWin-T24181-GLOBAL | 224² | 83.1 | 1303/2210 imgs/s | 20M | 7.60 G/4.09 G |

The comparison of top-1 test accuracy (Acc.), inference throughput (FPS), parameter numbers (#), and number of floating point operations (FLOPs) obtained by using the ELFATT modules to replace the vanilla softmax-based attention modules in different levels of CSWin-T24181-GLOBAL on ImageNet-1K. Note: Inference throughput is obtained using a batch size of 512 with mixed precision on a single NVIDIA H20 (96 GB) GPU. The best values are in bold. “Res.” denotes resolution, “imgs” denotes images, “nFA” denotes non-FlashAttention-2 acceleration, and “FA” denotes FlashAttention-2 acceleration. ✓ denotes the level consists of full ELFATT modules and ✓ denotes half of this level is composed of ELFATT modules and the other half is composed of vanilla softmax-based attention (VaniATT) modules. The order of composition is: VaniATT-ELFATT- . . . -VaniATT-ELFATT.

E. Ablation Study of Different Combinations of c₁ and c₂

Table V shows the performance comparison of CSWin-T24181-ELFATT using different combinations of c₁ and c₂ on ImageNet-1K. When c₁=1×c and c₂=0×c, ELFATT becomes EFFATT, and when c₁=0×c and c₂=1×c, ELFATT becomes a local window-based attention mechanism which can be regarded as a simpler version of the local window-based attention mechanism used in Swin. As shown in Table V, c₁=0.5×c and c₂=0.5×c, and c₁=0.75×c and c₂=0.25×c achieve better performance than other combinations of c₁ and c₂. Without using FlashAttention-2 acceleration, the difference between c₁=0.5×c and c₂=0.5×c, and c₁=0.75×c and c₂=0.25×c in terms of speed is not significant. Using FlashAttention-2 acceleration, c₁=0×c and c₂=1×c, and c₁=0.5×c and c₂=0.5×c achieve close speed and are significantly faster than other combinations.

TABLE V

| Combinations of c₁ and c₂ | | | | | | |
|---|---|---|---|---|---|---|
| c₁ | c₂ | Res. | Acc. | FPS (nFA/FA) | # | FLOPs (nFA/FA) |
| 0 × c | 1 × c | 224² | 82.7 | 2331/2880 imgs/s | 20M | 4.76 G/4.09 G |
| 0.25 × c | 0.75 × c | 224² | 83.0 | 2530/2835 imgs/s | 20M | 4.65 G/4.10 G |
| 0.5 × c | 0.5 × c | 224² | 83.1 | 2512/2881 imgs/s | 20M | 4.56 G/4.13 G |
| 0.75 × c | 0.25 × c | 224² | 83.1 | 2458/2796 imgs/s | 20M | 4.48 G/4.18 G |
| 1 × c | 0 × c | 224² | 82.6 | 2394/2526 imgs/s | 20M | 4.35 G/4.17 G |

The comparison of top-1 test accuracy (Acc.), inference throughput (FPS), parameter numbers (#), and number of floating point operations (FLOPs) obtained by CSWin-T24181-ELFATT using different combinations of c₁ and c₂ on ImageNet-1K. Note: Inference throughput is obtained using a batch size of 512 with mixed precision on a single NVIDIA H20 (96 GB) GPU. The best values are in bold. “Res.” denotes resolution, “imgs” denotes images, “nFA” denotes non-FlashAttention-2 acceleration, and “FA” denotes FlashAttention-2 acceleration.

### F. Object Detection Performance

Table VI shows the object detection performance of all methods on MS COCO 2017. Using the Mask-RCNN [47] 1× schedule, the vanilla softmax-based attention mechanism and ELFATT significantly outperform other attention mechanisms. ELFATT exhibits slightly better performance than the vanilla softmax-based attention mechanism when using CSWin-T24181 as the backbone and significantly outperforms the vanilla softmax-based attention mechanism when using Swin-T as the backbone. Under the backbone of CSWin-T24181, ELFATT offers a 4.3× speedup over the vanilla softmax-based attention mechanism without using FlashAttention-2 acceleration and is still 1.8× faster than the vanilla softmax-based attention mechanism using FlashAttention-2 acceleration. When using Swin-T as the backbone, ELFATT offers a 6.5× speedup over the vanilla softmax-based attention mechanism without using FlashAttention-2 acceleration and is still 2.6× faster than the vanilla softmax-based attention mechanism using FlashAttention-2 acceleration. Using the Mask-RCNN [47] 3× multiscale training schedule, ELFATT still achieves the best performance. The vanilla softmax-based attention mechanism still outperforms most linear attention mechanisms when using Swin-T as the backbone. In the 1× schedule, ELFATT using CSWin-T24181 as the backbone achieves close performance compared to VMamba-T and significantly outperforms ConvNeXt-T. In the 3× multiscale training schedule, ELFATT using CSWin-T24181 as the backbone outperforms ConvNeXt-T and VMamba-T in terms of object detection performance.

TABLE VI

| | | | | | | | | | |
|---|---|---|---|---|---|---|---|---|---|
| Method | AP^{b} | AP₅₀^{b} | Ap₇₅^{b} | AP^{m} | AP₅₀^{m} | AP₇₅^{m} | FPS (nFA/FA) | # | FLOPs (nFA/FA) |

Mask-RCNN [47] 1 × schedule

| | | | | | | | | | |
|---|---|---|---|---|---|---|---|---|---|
| CSWin-T24181-Agent | 46.8 | 68.9 | 51.3 | 42.3 | 65.9 | 45.3 | 19/20 imgs/s | 40M | 273.87 G/254.51 G |
| CSWin-T24181-EFFATT | 46.1 | 68.3 | 50.5 | 41.9 | 65.5 | 45.3 | 32/36 imgs/s | 40M | 329.95 G/255.20 G |
| CSWin-T24181-ELFATT | 47.0 | 69.2 | 51.4 | 42.6 | 66.4 | 45.9 | 30/33 imgs/s | 40M | 334.86 G/254.40 G |
| CSWin-T24181-FLatten | 46.6 | 68.8 | 51.0 | 42.2 | 65.7 | 45.3 | 26/28 imgs/s | 41M | 274.41 G/255.05 G |
| CSWin-T24181-GLOBAL | 47.0 | 69.1 | 51.9 | 42.6 | 66.1 | 45.9 | 7/18 imgs/s | 40M | 1712.76 G/253.56 G |
| CSWin-T24181-LOCAL | 46.5 | 68.5 | 51.0 | 42.1 | 65.6 | 45.3 | 26/28 imgs/s | 40M | 281.45 G/253.57 G |
| Swin-T-Agent | 44.6 | 67.5 | 48.7 | 40.7 | 64.4 | 43.4 | 5/— imgs/s | 48M | 278.42 G/— |
| Swin-T-EFFATT | 44.7 | 67.0 | 48.9 | 41.1 | 64.0 | 44.4 | 40/46 imgs/s | 48M | 301.89 G/261.95 G |
| Swin-T-ELFATT | 46.1 | 68.3 | 50.8 | 42.1 | 65.4 | 45.3 | 39/45 imgs/s | 50M | 311.39 G/266.43 G |
| Swin-T-FLatten | 44.2 | 67.3 | 48.5 | 40.2 | 63.8 | 43.0 | 41/— imgs/s | 49M | 266.43 G/— |
| Swin-T-GLOBAL | 45.4 | 67.9 | 49.7 | 41.6 | 65.0 | 44.8 | 6/17 imgs/s | 48M | 2106.75 G/260.48 G |
| Swin-T-LOCAL | 42.7 | 65.2 | 46.8 | 39.3 | 62.2 | 42.2 | 45/— imgs/s | 48M | 267.01 G/— |
| ConvNext-T | 44.2 | 66.6 | 48.3 | 40.1 | 63.3 | 42.8 | 44/— imgs/s | 48M | 262.29 G/— |
| VMamba-T | 47.4 | 69.5 | 52.0 | 42.7 | 66.3 | 46.0 | 35/— imgs/s | 50M | 271.16 G/— |

Mask-RCNN [47] 3 × MS schedule

| | | | | | | | | | |
|---|---|---|---|---|---|---|---|---|---|
| CSWin-T24181-Agent | 49.3 | 70.8 | 53.9 | 43.9 | 67.9 | 47.3 | 19/20 imgs/s | 40M | 273.87 G/254.51 G |
| CSWin-T24181-EFFATT | 48.5 | 70.0 | 53.2 | 43.4 | 67.3 | 46.9 | 32/36 imgs/s | 40M | 329.95 G/255.20 G |
| CSWin-T24181-ELFATT | 49.4 | 70.9 | 54.4 | 44.0 | 68.0 | 47.5 | 30/33 imgs/s | 40M | 334.86 G/254.40 G |
| CSWin-T24181-FLatten | 48.9 | 70.8 | 53.5 | 43.9 | 67.9 | 47.3 | 26/28 imgs/s | 41M | 274.41 G/255.05 G |
| CSWin-T24181-GLOBAL | 48.8 | 70.0 | 53.5 | 43.6 | 67.4 | 47.1 | 7/18 imgs/s | 40M | 1712.76 G/253.56 G |
| CSWin-T24181-LOCAL | 49.3 | 70.8 | 54.3 | 44.0 | 67.8 | 47.5 | 26/28 imgs/s | 40M | 281.45 G/253.57 G |
| Swin-T-Agent | 47.3 | 69.5 | 51.9 | 42.7 | 66.4 | 46.2 | 5/— imgs/s | 48M | 278.42 G/— |
| Swin-T-EFFATT | 47.6 | 69.4 | 52.6 | 42.7 | 65.9 | 46.1 | 40/46 imgs/s | 48M | 301.89 G/261.95 G |
| Swin-T-ELFATT | 48.5 | 70.4 | 53.4 | 43.6 | 67.3 | 47.3 | 39/45 imgs/s | 50M | 311.39 G/266.43 G |
| Swin-T-FLatten | 46.5 | 68.5 | 50.8 | 42.1 | 65.4 | 45.1 | 41/— imgs/s | 49M | 266.43 G/— |
| Swin-T-GLOBAL | 48.0 | 70.0 | 52.7 | 43.3 | 67.0 | 46.8 | 6/17 imgs/s | 48M | 2106.75 G/260.48 G |
| Swin-T-LOCAL | 46.0 | 68.1 | 50.3 | 41.6 | 65.1 | 44.9 | 45/— imgs/s | 48M | 267.01 G/— |
| ConvNeXt-T | 46.2 | 67.9 | 50.8 | 41.7 | 65.0 | 44.9 | 44/— imgs/s | 48M | 262.29 G/— |
| VMamba-T | 48.9 | 70.6 | 53.6 | 43.7 | 67.7 | 46.8 | 35/— imgs/s | 50M | 271.16 G/— |

The comparison of object detection performance of all methods on MS COCO 2017. Note: FLOPs are calculated using an input size of 1280×800. “1×” denotes the fine-tuning training schedule with 12 epochs and “3×MS” represents fine-tuning using the multiscale training schedule with 36 epochs. “-” denotes the corresponding method cannot be accelerated by FlashAttention-2. AP^{b} denotes box average precision and AP^{m} denotes mask average precision. Inference throughput is obtained using a batch size of 1 with mixed precision on a single NVIDIA H20 (96 GB) GPU. “imgs” denotes images, “nFA” denotes non-FlashAttention-2 acceleration, and “FA” denotes FlashAttention-2 acceleration.

### G. Semantic Segmentation Performance

Table VII shows the comparison of semantic segmentation performance of all methods on ADE20K. The vanilla softmax-based attention mechanism and ELFATT achieve close mean class accuracy (mAcc) and mean intersection over union (mIoU), and significantly outperform other attention mechanisms when using Swin-T as the backbone. ELFATT, FLatten, the vanilla softmax-based attention mechanism, and the local window-based attention mechanism [23] achieve close mean class accuracy when using CSWin-T24181 as the backbone. However, ELFATT and the local window-based attention mechanism [23] significantly outperform other attention mechanisms in terms of mean intersection over union. Without using FlashAttention-2 acceleration, ELFATT offers a nearly 5× speedup over the vanilla softmax-based attention mechanism using CSWin-T24181 as the backbone and a 7× speedup over the vanilla softmax-based attention mechanism using Swin-T as the backbone. Even using FlashAttention-2 acceleration, under the CSWin-T24181 backbone, the vanilla softmax-based attention mechanism is still 2× slower than ELFATT without using FlashAttention-2 acceleration and 2.3× slower than ELFATT using FlashAttention-2 acceleration. Under the Swin-T backbone, the vanilla softmax-based attention mechanism is still 2.4× slower than ELFATT without using FlashAttention-2 acceleration and 2.7× slower than ELFATT using FlashAttention-2 acceleration. The speed of ELFATT is almost the same as the speed of EFFATT which is a real linear attention mechanism. However, ELFATT achieves significantly higher mean class accuracy and mean intersection over union than those of EFFATT. ELFATT using CSWin-T24181 as the backbone outperforms ConvNeXt-T and VMamba-T in terms of semantic segmentation performance.

TABLE VII

| | UperNet [48] 160 k | | | | | |
|---|---|---|---|---|---|---|
| Method | mAcc (%) | mIoU (%) | FPS (nFA/FA) | | # | FLOPs (nFA/FA) |
| CSWin-T24181-Agent | 60.8 | 48.5 | 16/17 | imgs/s | 50 M | 953.60 G/929.64 G |
| CSWin-T24181-EFFATT | 60.6 | 48.8 | 28/33 | imgs/s | 50 M | 1008.73 G/930.34 G |
| CSWin-T24181-ELFATT | 61.2 | 49.6 | 28/32 | imgs/s | 50 M | 1014.26 G/929.53 G |
| CSWin-T24181-FLatten | 61.4 | 49.3 | 25/27 | imgs/s | 51 M | 954.15 G/930.19 G |
| CSWin-T24181-GLOBAL | 61.1 | 48.8 | 6/14 | imgs/s | 50 M | 2458.75 G/928.67 G |
| CSWin-T24181-LOCAL | 61.1 | 49.6 | 26/28 | imgs/s | 50 M | 963.38 G/928.68 G |
| Swin-T-Agent | 58.5 | 46.7 | 4/— | imgs/s | 61 M | 957.50 G/— |
| Swin-T-EFFATT | 58.3 | 46.7 | 35/39 | imgs/s | 60 M | 981.22 G/939.35 G |
| Swin-T-ELFATT | 59.3 | 47.7 | 34/38 | imgs/s | 62 M | 991.27 G/943.94 G |
| Swin-T-FLatten | 57.0 | 44.8 | 35/— | imgs/s | 61 M | 944.62 G/— |
| Swin-T-GLOBAL | 59.3 | 47.8 | 5/14 | imgs/s | 60 M | 2873.79 G/937.84 G |
| Swin-T-LOCAL | 55.6 | 44.5 | 38/— | imgs/s | 60 M | 945.66 G/— |
| ConvNeXt-T | 58.3 | 46.1 | 37/— | imgs/s | 60 M | 939.69 G/— |
| VMamba-T | 59.3 | 47.9 | 34/— | imgs/s | 62 M | 948.78 G/— |

The comparison of semantic segmentation performance of all methods on ADE20K. Note: The best values are in bold, “mAcc” denotes mean class accuracy, and “mIoU” denotes mean intersection over union. “-” denotes the corresponding method cannot be accelerated by FlashAttention-2. FLOPs are calculated using an input size of 512×2048. “160 k” denotes the 160 k fine-tuning iterations. Inference throughput is obtained using a batch size of 1 with mixed precision on a single NVIDIA H20 (96 GB) GPU. “imgs” denotes images, “nFA” denotes non-FlashAttention-2 acceleration, and “FA” denotes FlashAttention-2 acceleration.

### H. Speed Comparison on Edge GPUs

Table VIII shows the comparison of inference speed of different attention mechanisms obtained on ImageNet-1K using an NVIDIA Jetson AGX Orin GPU. In FP32 precision, under the backbone of CSWin-T24181, ELFATT achieves the highest FPS and only the local window-based attention mechanism [23] has a close speed compared to ELFATT. However, in mixed precision, ELFATT is significantly faster than all other attention mechanisms, as shown in Table VIII. Also, from Table VIII, FLatten is even slower than the vanilla softmax-based attention mechanism in mixed precision on the edge GPU. Because FLatten uses a lot of normalization and reshaping operations in addition to linear attention. It further shows that these kinds of linear attention are not linear for all platforms. Even compared to EfficientViT-B2 [49], to achieve similar accuracy, ELFATT is significantly faster than EfficientViT-B2 in mixed precision on the edge GPU.

TABLE VIII

| Method | Res. | FPS (FP32) | Speedup ratio | FPS (Mixed precision) | Speedup ratio |
|---|---|---|---|---|---|
| CSWin-T24181-Agent | 224² | 158 imgs/s | 1.5 x | 295 imgs/s | 1.3 x |
| CSWin-T24181-EFFATT | 224² | 156 imgs/s | 1.4 x | 305 imgs/s | 1.3 x |
| CSWin-T24181-ELFATT | 224² | 174 imgs/s | 1.6 x | 355 imgs/s | 1.6 x |
| CSWin-T24181-FLatten | 224² | 138 imgs/s | 1.3 x | 229 imgs/s | 1.0 x |
| CSWin-T24181-GLOBAL | 224² | 108 imgs/s | 1.0 x | 298 imgs/s | 1.3 x |
| CSWin-T24181-LOCAL | 224² | 167 imgs/s | 1.5 x | 309 imgs/s | 1.3 x |
| EfficientViT-B2 | 288² | 198 imgs/s | 1.8 x | 282 imgs/s | 1.2 x |

The comparison of inference throughput of different attention mechanisms obtained on ImageNet-1K (Platform: NVIDIA Jetson AGX Orin; Batch Size: 128; Mode: 60 W (Orin MAXN)).

### V. CONCLUSION

In the present invention, there is provided a novel efficient linear fast attention (ELFATT) mechanism for ViTs to achieve low memory I/O operations, linear computational complexity, and high performance at the same time. ELFATT offers 4-7× speedups over the vanilla softmax-based attention mechanism in high-resolution vision tasks without losing performance. ELFATT is compatible with FlashAttention. Using FlashAttention-2 acceleration, ELFATT still offers 2-3× speedups over the vanilla softmax-based attention mechanism in high-resolution vision tasks without losing performance. ELFATT without using FlashAttention-2 acceleration is even faster than the vanilla softmax-based attention mechanism using FlashAttention-2 acceleration on both low-resolution and high-resolution vision datasets, which shows great potential of ELFATT.

### REFERENCES

[1] OpenAI, J. Achiam, S. Adler, S. Agarwal, L. Ahmad, I. Akkaya, F. L. Aleman, D. Almeida, J. Altenschmidt, S. Altman, S. Anadkat, R. Avila, I. Babuschkin, S. Balaji, V. Balcom, P. Baltescu, H. Bao, M. Bavarian, J. Belgum, I. Bello, J. Berdine, G. Bernadett-Shapiro, C. Berner, L. Bogdonoff, O. Boiko, M. Boyd, A.-L. Brakman, G. Brockman, T. Brooks, M. Brundage, K. Button, T. Cai, R. Campbell, A. Cann, B. Carey, C. Carlson, R. Carmichael, B. Chan, C. Chang, F. Chantzis, D. Chen, S. Chen, R. Chen, J. Chen, M. Chen, B. Chess, C. Cho, C. Chu, H. W. Chung, D. Cummings, J. Currier, Y. Dai, C. Decareaux, T. Degry, N. Deutsch, D. Deville, A. Dhar, D. Dohan, S. Dowling, S. Dunning, A. Ecoffet, A. Eleti, T. Eloundou, D. Farhi, L. Fedus, N. Felix, S. P. Fishman, J. Forte, I. Fulford, L. Gao, E. Georges, C. Gibson, V. Goel, T. Gogineni, G. Goh, R. Gontijo-Lopes, J. Gordon, M. Grafstein, S. Gray, R. Greene, J. Gross, S. S. Gu, Y. Guo, C. Hallacy, J. Han, J. Harris, Y. He, M. Heaton, J. Heidecke, C. Hesse, A. Hickey, W. Hickey, P. Hoeschele, B. Houghton, K. Hsu, S. Hu, X. Hu, J. Huizinga, S. Jain, S. Jain, J. Jang, A. Jiang, R. Jiang, H. Jin, D. Jin, S. Jomoto, B. Jonn, H. Jun, T. Kaftan, Łukasz Kaiser, A. Kamali, I. Kanitscheider, N. S. Keskar, T. Khan, L. Kilpatrick, J. W. Kim, C. Kim, Y. Kim, J. H. Kirchner, J. Kiros, M. Knight, D. Kokotajlo, Łukasz Kondraciuk, A. Kondrich, A. Konstantinidis, K. Kosic, G. Krueger, V. Kuo, M. Lampe, I. Lan, T. Lee, J. Leike, J. Leung, D. Levy, C. M. Li, R. Lim, M. Lin, S. Lin, M. Litwin, T. Lopez, R. Lowe, P. Lue, A. Makanju, K. Malfacini, S. Manning, T. Markov, Y. Markovski, B. Martin, K. Mayer, A. Mayne, B. McGrew, S. M. McKinney, C. McLeavey, P. McMillan, J. McNeil, D. Medina, A. Mehta, J. Menick, L. Metz, A. Mishchenko, P. Mishkin, V. Monaco, E. Morikawa, D. Mossing, T. Mu, M. Murati, O. Murk, D. Mély, A. Nair, R. Nakano, R. Nayak, A. Neelakantan, R. Ngo, H. Noh, L. Ouyang, C. O'Keefe, J. Pachocki, A. Paino, J. Palermo, A. Pantuliano, G. Parascandolo, J. Parish, E. Parparita, A. Passos, M. Pavlov, A. Peng, A. Perelman, F. de Avila Belbute Peres, M. Petrov, H. P. de Oliveira Pinto, Michael, Pokorny, M. Pokrass, V. H. Pong, T. Powell, A. Power, B. Power, E. Proehl, R. Puri, A. Radford, J. Rae, A. Ramesh, C. Raymond, F. Real, K. Rimbach, C. Ross, B. Rotsted, H. Roussez, N. Ryder, M. Saltarelli, T. Sanders, S. Santurkar, G. Sastry, H. Schmidt, D. Schnurr, J. Schulman, D. Selsam, K. Sheppard, T. Sherbakov, J. Shieh, S. Shoker, P. Shyam, S. Sidor, E. Sigler, M. Simens, J. Sitkin, K. Slama, I. Sohl, B. Sokolowsky, Y. Song, N. Staudacher, F. P. Such, N. Summers, I. Sutskever, J. Tang, N. Tezak, M. B. Thompson, P. Tillet, A. Tootoonchian, E. Tseng, P. Tuggle, N. Turley, J. Tworek, J. F. C. Uribe, A. Vallone, A. Vijayvergiya, C. Voss, C. Wainwright, J. J. Wang, A. Wang, B. Wang, J. Ward, J. Wei, C. Weinmann, A. Welihinda, P. Welinder, J. Weng, L. Weng, M. Wiethoff, D. Willner, C. Winter, S. Wolrich, H. Wong, L. Workman, S. Wu, J. Wu, M. Wu, K. Xiao, T. Xu, S. Yoo, K. Yu, Q. Yuan, W. Zaremba, R. Zellers, C. Zhang, M. Zhang, S. Zhao, T. Zheng, J. Zhuang, W. Zhuk, and B. Zoph, “GPT-4 technical report,” 2024. [Online]. Available: https://arxiv.org/abs/2303.08774
[2] A. Dubey, A. Jauhri, A. Pandey, A. Kadian, A. Al-Dahle, A. Letman, A. Mathur, A. Schelten, A. Yang, A. Fan, A. Goyal, A. Hartshorn, A. Yang, A. Mitra, A. Sravankumar, A. Korenev, A. Hinsvark, A. Rao, A. Zhang, A. Rodriguez, A. Gregerson, A. Spataru, B. Roziere, B. Biron, B. Tang, B. Chern, C. Caucheteux, C. Nayak, C. Bi, C. Marra, C. McConnell, C. Keller, C. Touret, C. Wu, C. Wong, C. C. Ferrer, C. Nikolaidis, D. Allonsius, D. Song, D. Pintz, D. Livshits, D. Esiobu, D. Choudhary, D. Mahajan, D. Garcia-Olano, D. Perino, D. Hupkes, E. Lakomkin, E. AlBadawy, E. Lobanova, E. Dinan, E. M. Smith, F. Radenovic, F. Zhang, G. Synnaeve, G. Lee, G. L. Anderson, G. Nail, G. Mialon, G. Pang, G. Cucurell, H. Nguyen, H. Korevaar, H. Xu, H. Touvron, I. Zarov, I. A. Ibarra, I. Kloumann, I. Misra, I. Evtimov, J. Copet, J. Lee, J. Geffert, J. Vranes, J. Park, J. Mahadeokar, J. Shah, J. van der Linde, J. Billock, J. Hong, J. Lee, J. Fu, J. Chi, J. Huang, J. Liu, J. Wang, J. Yu, J. Bitton, J. Spisak, J. Park, J. Rocca, J. Johnstun, J. Saxe, J. Jia, K. V. Alwala, K. Upasani, K. Plawiak, K. Li, K. Heafield, K. Stone, K. El-Arini, K. Iyer, K. Malik, K. Chiu, K. Bhalla, L. Rantala-Yeary, L. van der Maaten, L. Chen, L. Tan, L. Jenkins, L. Martin, L. Madaan, L. Malo, L. Blecher, L. Landzaat, L. de Oliveira, M. Muzzi, M. Pasupuleti, M. Singh, M. Paluri, M. Kardas, M. Oldham, M. Rita, M. Pavlova, M. Kambadur, M. Lewis, M. Si, M. K. Singh, M. Hassan, N. Goyal, N. Torabi, N. Bashlykov, N. Bogoychev, N. Chatterji, O. Duchenne, O. Çelebi, P. Alrassy, P. Zhang, P. Li, P. Vasic, P. Weng, P. Bhargava, P. Dubal, P. Krishnan, P. S. Koura, P. Xu, Q. He, Q. Dong, R. Srinivasan, R. Ganapathy, R. Calderer, R. S. Cabral, R. Stojnic, R. Raileanu, R. Girdhar, R. Patel, R. Sauvestre, R. Polidoro, R. Sumbaly, R. Taylor, R. Silva, R. Hou, R. Wang, S. Hosseini, S. Chennabasappa, S. Singh, S. Bell, S. S. Kim, S. Edunov, S. Nie, S. Narang, S. Raparthy, S. Shen, S. Wan, S. Bhosale, S. Zhang, S. Vandenhende, S. Batra, S. Whitman, S. Sootla, S. Collot, S. Gururangan, S. Borodinsky, T. Herman, T. Fowler, T. Sheasha, T. Georgiou, T. Scialom, T. Speckbacher, T. Mihaylov, T. Xiao, U. Karn, V. Goswami, V. Gupta, V. Ramanathan, V. Kerkez, V. Gonguet, V. Do, V. Vogeti, V. Petrovic, W. Chu, W. Xiong, W. Fu, W. Meers, X. Martinet, X. Wang, X. E. Tan, X. Xie, X. Jia, X. Wang, Y. Goldschlag, Y. Gaur, Y. Babaei, Y. Wen, Y. Song, Y. Zhang, Y. Li, Y. Mao, Z. D. Coudert, Z. Yan, Z. Chen, Z. Papakipos, A. Singh, A. Grattafiori, A. Jain, A. Kelsey, A. Shajnfeld, A. Gangidi, A. Victoria, A. Goldstand, A. Menon, A. Sharma, A. Boesenberg, A. Vaughan, A. Baevski, A. Feinstein, A. Kallet, A. Sangani, A. Yunus, A. Lupu, A. Alvarado, A. Caples, A. Gu, A. Ho, A. Poulton, A. Ryan, A. Ramchandani, A. Franco, A. Saraf, A. Chowdhury, A. Gabriel, A. Bharambe, A. Eisenman, A. Yazdan, B. James, B. Maurer, B. Leonhardi, B. Huang, B. Loyd, B. D. Paola, B. Paranjape, B. Liu, B. Wu, B. Ni, B. Hancock, B. Wasti, B. Spence, B. Stojkovic, B. Gamido, B. Montalvo, C. Parker, C. Burton, C. Mejia, C. Wang, C. Kim, C. Zhou, C. Hu, C.-H. Chu, C. Cai, C. Tindal, C. Feichtenhofer, D. Civin, D. Beaty, D. Kreymer, D. Li, D. Wyatt, D. Adkins, D. Xu, D. Testuggine, D. David, D. Parikh, D. Liskovich, D. Foss, D. Wang, D. Le, D. Holland, E. Dowling, E. Jamil, E. Montgomery, E. Presani, E. Hahn, E. Wood, E. Brinkman, E. Arcaute, E. Dunbar, E. Smothers, F. Sun, F. Kreuk, F. Tian, F. Ozgenel, F. Caggioni, F. Guzmin, F. Kanayet, F. Seide, G. M. Florez, G. Schwarz, G. Badeer, G. Swee, G. Halpern, G. Thattai, G. Herman, G. Sizov, Guangyi, Zhang, G. Lakshminarayanan, H. Shojanazeri, H. Zou, H. Wang, H. Zha, H. Habeeb, H. Rudolph, H. Suk, H. Aspegren, H. Goldman, I. Damlaj, I. Molybog, I. Tufanov, I.-E. Veliche, I. Gat, J. Weissman, J. Geboski, J. Kohli, J. Asher, J.-B. Gaya, J. Marcus, J. Tang, J. Chan, J. Zhen, J. Reizenstein, J. Teboul, J. Zhong, J. Jin, J. Yang, J. Cummings, J. Carvill, J. Shepard, J. McPhie, J. Torres, J. Ginsburg, J. Wang, K. Wu, K. H. U, K. Saxena, K. Prasad, K. Khandelwal, K. Zand, K. Matosich, K. Veeraraghavan, K. Michelena, K. Li, K. Huang, K. Chawla, K. Lakhotia, K. Huang, L. Chen, L. Garg, L. A, L. Silva, L. Bell, L. Zhang, L. Guo, L. Yu, L. Moshkovich, L. Wehrstedt, M. Khabsa, M. Avalani, M. Bhatt, M. Tsimpoukelli, M. Mankus, M. Hasson, M. Lennie, M. Reso, M. Groshev, M. Naumov, M. Lathi, M. Keneally, M. L. Seltzer, M. Valko, M. Restrepo, M. Patel, M. Vyatskov, M. Samvelyan, M. Clark, M. Macey, M. Wang, M. J. Hermoso, M. Metanat, M. Rastegari, M. Bansal, N. Santhanam, N. Parks, N. White, N. Bawa, N. Singhal, N. Egebo, N. Usunier, N. P. Laptev, N. Dong, N. Zhang, N. Cheng, O. Chernoguz, O. Hart, O. Salpekar, O. Kalinli, P. Kent, P. Parekh, P. Saab, P. Balaji, P. Rittner, P. Bontrager, P. Roux, P. Dollar, P. Zvyagina, P. Ratanchandani, P. Yuvraj, Q. Liang, R. Alao, R. Rodriguez, R. Ayub, R. Murthy, R. Nayani, R. Mitra, R. Li, R. Hogan, R. Battey, R. Wang, R. Maheswari, R. Howes, R. Rinott, S. J. Bondu, S. Datta, S. Chugh, S. Hunt, S. Dhillon, S. Sidorov, S. Pan, S. Verma, S. Yamamoto, S. Ramaswamy, S. Lindsay, S. Lindsay, S. Feng, S. Lin, S. C. Zha, S. Shankar, S. Zhang, S. Zhang, S. Wang, S. Agarwal, S. Sajuyigbe, S. Chintala, S. Max, S. Chen, S. Kehoe, S. Satterfield, S. Govindaprasad, S. Gupta, S. Cho, S. Virk, S. Subramanian, S. Choudhury, S. Goldman, T. Remez, T. Glaser, T. Best, T. Kohler, T. Robinson, T. Li, T. Zhang, T. Mathews, T. Chou, T. Shaked, V. Vontimitta, V. Ajayi, V. Montanez, V. Mohan, V. S. Kumar, V. Mangla, V. Albiero, V. Ionescu, V. Poenaru, V. T. Mihailescu, V. Ivanov, W. Li, W. Wang, W. Jiang, W. Bouaziz, W. Constable, X. Tang, X. Wang, X. Wu, X. Wang, X. Xia, X. Wu, X. Gao, Y. Chen, Y. Hu, Y. Jia, Y. Qi, Y. Li, Y. Zhang, Y. Zhang, Y. Adi, Y. Nam, Yu, Wang, Y. Hao, Y. Qian, Y. He, Z. Rait, Z. DeVito, Z. Rosnbrick, Z. Wen, Z. Yang, and Z. Zhao, “The Llama 3 herd of models,” 2024. [Online]. Available: https://arxiv.org/abs/2407.21783
[3] A. Kirillov, E. Mintun, N. Ravi, H. Mao, C. Rolland, L. Gustafson, T. Xiao, S. Whitehead, A. C. Berg, W.-Y. Lo, P. Dollár, and R. Girshick, “Segment anything,” 2023. [Online]. Available: https://arxiv.org/abs/2304.02643
[4] T. Brooks, B. Peebles, C. Holmes, W. DePue, Y. Guo, L. Jing, D. Schnurr, J. Taylor, T. Luhman, E. Luhman, C. Ng, R. Wang, and A. Ramesh, “Video generation models as world simulators,” 2024. [Online]. Available: https://openai.com/research/video-generation-models-as-world-simulators
[5] C. Wu, M. Che, and H. Yan, “The cur decomposition of self-attention matrices in vision transformers,” August 2024. [Online]. Available: http://dx.doi.org/10.36227/techrxiv.171392846.60982484/v2
[6] T. Dao, D. Y. Fu, S. Ermon, A. Rudra, and C. Ré, “FlashAttention: Fast and memory-efficient exact attention with IO-awareness,” 2022. [Online]. Available: https://arxiv.org/abs/2205.14135
[7] T. Dao, “FlashAttention-2: Faster attention with better parallelism and work partitioning,” in The Twelfth International Conference on Learning Representations, 2024. [Online]. Available: https://openreview.net/forum?id=mZn2Xyh9Ec
[8] J. Shah, G. Bikshandi, Y. Zhang, V. Thakkar, P. Ramani, and T. Dao, “FlashAttention-3: Fast and accurate attention with asynchrony and lowprecision,” 2024. [Online]. Available: https://arxiv.org/abs/2407.08608
[9] J. Ramapuram, F. Danieli, E. Dhekane, F. Weers, D. Busbridge, P. Ablin, T. Likhomanenko, J. Digani, Z. Gu, A. Shidani, and R. Webb, “Theory, analysis, and best practices for sigmoid self-attention,” 2024. [Online]. Available: https://arxiv.org/abs/2409.04431
[10] D. Han, X. Pan, Y. Han, S. Song, and G. Huang, “FLatten transformer: Vision transformer using focused linear attention,” in Proceedings of the IEEE/CVF International Conference on Computer Vision (ICCV), 2023, pp. 5961-5971.
[11] K. M. Choromanski, V. Likhosherstov, D. Dohan, X. Song, A. Gane, T. Sarlos, P. Hawkins, J. Q. Davis, A. Mohiuddin, L. Kaiser, D. B. Belanger, L. J. Colwell, and A. Weller, “Rethinking attention with performers,” in International Conference on Learning Representations, 2021. [Online]. Available: https://openreview.net/forum?id=Ua6zuk0WRH
[12] M. Wortsman, J. Lee, J. Gilmer, and S. Kornblith, “Replacing softmax with ReLU in vision transformers,” arXiv preprint arXiv:2309.08586, 2023.
[13] A. Katharopoulos, A. Vyas, N. Pappas, and F. Fleuret, “Transformers are RNNs: Fast autoregressive transformers with linear attention,” in Proceedings of the 37th International Conference on Machine Learning, ser. Proceedings of Machine Learning Research, H. D. III and A. Singh, Eds., vol. 119. PMLR, 2020, pp. 5156-5165. [Online]. Available: https://proceedings.mlr.press/v1 19/katharopoulos20a.html
[14] D. Bolya, C.-Y. Fu, X. Dai, P. Zhang, and J. Hoffman, “Hydra attention: Efficient attention with many heads,” in Computer Vision—ECCV 2022 Workshops, L. Karlinsky, T. Michaeli, and K. Nishino, Eds. Cham: Springer Nature Switzerland, 2023, pp. 35-49.
[15] J. Lu, J. Yao, J. Zhang, X. Zhu, H. Xu, W. Gao, C. Xu, T. Xiang, and L. Zhang, “SOFT: Softmax-free transformer with linear complexity,” in Advances in Neural Information Processing Systems, M. Ranzato, A. Beygelzimer, Y. Dauphin, P. Liang, and J. W. Vaughan, Eds., vol. 34. Curran Associates, Inc., 2021, pp. 21297 21 309. [Online]. Available: https://proceedings.neurips.cc/paper_files/paper/2021/file/b1d10e7bafa4421218a51b1e 1f1b0ba2-Paper.pdf
[16] H. Peng, N. Pappas, D. Yogatama, R. Schwartz, N. Smith, and L. Kong, “Random feature attention,” in International Conference on Learning Representations, 2021. [Online]. Available: https://openreview.net/forum?id=QtTKTdVrFBB
[17] Z. Qin, W. Sun, H. Deng, D. Li, Y. Wei, B. Lv, J. Yan, L. Kong, and Y. Zhong, “cosFormer: Rethinking softmax in attention,” in International Conference on Learning Representations, 2022. [Online]. Available: https://openreview.net/forum?id=B18CQrx2Up4
[18] Z. Shen, M. Zhang, H. Zhao, S. Yi, and H. Li, “Efficient attention: Attention with linear complexities,” in Proceedings of the IEEE/CVF Winter Conference on Applications of Computer Vision (WACV), 2021, pp. 3531-3539.
[19] D. Han, T. Ye, Y. Han, Z. Xia, S. Pan, P. Wan, S. Song, and G. Huang, “Agent Attention: On the integration of softmax and linear attention,” 2024. [Online]. Available: https://arxiv.org/abs/2312.08874
[20] J. Han, L. Zeng, L. Du, X. Ye, W. Ding, and J. Feng, “Modify self-attention via skeleton decomposition for effective point cloud transformer,” Proceedings of the AAAI Conference on Artificial Intelligence, vol. 36, no. 1, pp. 808-816, 2022.
[21] Y. Xiong, Z. Zeng, R. Chakraborty, M. Tan, G. Fung, Y. Li, and V. Singh, “Nystrómformer: A Nyström-based algorithm for approximating selfattention,” Proceedings of the AAAI Conference on Artificial Intelligence, vol. 35, no. 16, pp. 14 138-14 148, 2021.
[22] Z. Liu, Y. Lin, Y. Cao, H. Hu, Y. Wei, Z. Zhang, S. Lin, and B. Guo, “Swin transformer: Hierarchical vision transformer using shifted windows,” in Proceedings of the IEEE/CVF International Conference on Computer Vision (ICCV), 2021, pp. 10012-10 022.
[23] X. Dong, J. Bao, D. Chen, W. Zhang, N. Yu, L. Yuan, D. Chen, and B. Guo, “CSWin transformer: A general vision transformer backbone with cross-shaped windows,” in Proceedings of the IEEE/CVF Conference on Computer Vision and Pattern Recognition (CVPR), 2022, pp. 12 124-12 134.
[24] S. Wang, B. Z. Li, M. Khabsa, H. Fang, and H. Ma, “Linformer: Self-attention with linear complexity,” arXiv preprint arXiv:2006.04768, 2020.
[25] G. Zhao, J. Lin, Z. Zhang, X. Ren, Q. Su, and X. Sun, “Explicit sparse transformer: Concentrated attention through explicit selection,” CoRR, vol. abs/1912.11637, 2019. [Online]. Available: http://arxiv.org/abs/1912.11637
[26] I. Beltagy, M. E. Peters, and A. Cohan, “Longformer: The longdocument transformer,” CoRR, vol. abs/2004.05150, 2020. [Online]. Available: https://arxiv.org/abs/2004.05150
[27] R. Child, S. Gray, A. Radford, and I. Sutskever, “Generating long sequences with sparse transformers,” CoRR, vol. abs/1904.10509, 2019. [Online]. Available: http://arxiv.org/abs/1904.10509
[28] Y. Tay, D. Bahri, L. Yang, D. Metzler, and D.-C. Juan, “Sparse Sinkhorn attention,” in Proceedings of the 37th International Conference on Machine Learning, ser. Proceedings of Machine Learning Research, H. D. III and A. Singh, Eds., vol. 119. PMLR, 2020, pp. 9438-9447. [Online]. Available: https://proceedings.mlr.press/v119/tay20a.html
[29] M. Zaheer, G. Guruganesh, K. A. Dubey, J. Ainslie, C. Alberti, S. Ontanon, P. Pham, A. Ravula, Q. Wang, L. Yang, and A. Ahmed, “Big Bird: Transformers for longer sequences,” in Advances in Neural Information Processing Systems, H. Larochelle, M. Ranzato, R. Hadsell, M. Balcan, and H. Lin, Eds., vol. 33. Curran Associates, Inc., 2020, pp. 17283-17297. [Online]. Available: https://proceedings.neurips.cc/paper_files/paper/2020/file/c8512d142a2d849725f31a9a 7a361ab9-Paper.pdf
[30] N. Kitaev, L. Kaiser, and A. Levskaya, “Reformer: The efficient transformer,” in International Conference on Learning Representations, 2020. [Online]. Available: https://openreview.net/forum?id=rkgNKkHtvB
[31] H. Wang, Z. Wang, M. Du, F. Yang, Z. Zhang, S. Ding, P. Mardziel, and X. Hu, “Score-CAM: Score-weighted visual explanations for convolutional neural networks,” in Proceedings of the IEEE/CVF Conference on Computer Vision and Pattern Recognition (CVPR) Workshops, 2020.
[32] V. Nair and G. E. Hinton, “Rectified linear units improve restricted boltzmann machines,” in Proceedings of the 27th International Conference on International Conference on Machine Learning, ser. ICML'10. Madison, WI, USA: Omnipress, 2010, p. 807-814.
[33] D.-A. Clevert, “Fast and accurate deep network learning by exponential linear units (ELUs),” arXiv preprint arXiv:1511.07289, 2015.
[34] H. Kang, M.-H. Yang, and J. Ryu, “Interactive multi-head self-attention with linear complexity,” 2024.
[35] Z. Zhang, H. Zhang, L. Zhao, T. Chen, S. Ö. Arik, and T. Pfister, “Nested hierarchical transformer: Towards accurate, data-efficient and interpretable visual understanding,” Proceedings of the AAAI Conference on Artificial Intelligence, vol. 36, no. 3, pp. 3417-3425, 2022.
[36] F. Yu, “Multi-scale context aggregation by dilated convolutions,” arXiv preprint arXiv:1511.07122, 2015.
[37] R. A. Horn and C. R. Johnson, Matrix Analysis, 2nd ed. Cambridge University Press, 2012.
[38] G. H. Golub and C. F. Van Loan, Matrix Computations, 4th ed. Johns Hopkins University Press, Baltimore, MD, 2013.
[39] A. Vaswani, N. Shazeer, N. Parmar, J. Uszkoreit, L. Jones, A. N. Gomez, L. u. Kaiser, and I. Polosukhin, “Attention is all you need,” in Advances in Neural Information Processing Systems, I. Guyon, U. V. Luxburg, S. Bengio, H. Wallach, R. Fergus, S. Vishwanathan, and R. Garnett, Eds., vol. 30. Curran Associates, Inc., 2017. [Online]. Available: https://proceedings.neurips.cc/paper_files/paper/2017/file/3f5ee243547dee91fbd053c1c4a845aa-Paper.pdf
[40] P. Shaw, J. Uszkoreit, and A. Vaswani, “Self-attention with relative position representations,” in Proceedings of the 2018 Conference of the North American Chapter of the Association for Computational Linguistics: Human Language Technologies, Volume 2 (Short Papers), M. Walker, H. Ji, and A. Stent, Eds. New Orleans, Louisiana: Association for Computational Linguistics, June 2018, pp. 464-468. [Online]. Available: https://aclanthology.org/N18-2074
[41] X. Chu, Z. Tian, B. Zhang, X. Wang, and C. Shen, “Conditional positional encodings for vision transformers,” in The Eleventh International Conference on Learning Representations, 2023. [Online]. Available: https://openreview.net/forum?id=3KWnuT-R1bh
[42] O. Russakovsky, J. Deng, H. Su, J. Krause, S. Satheesh, S. Ma, Z. Huang, A. Karpathy, A. Khosla, M. Bernstein, A. C. Berg, and L. FeiFei, “ImageNet large scale visual recognition challenge,” International Journal of Computer Vision (IJCV), vol. 115, no. 3, pp. 211-252, 2015.
[43] B. Zhou, H. Zhao, X. Puig, S. Fidler, A. Barriuso, and A. Torralba, “Scene parsing through ADE20K dataset,” in 2017 IEEE Conference on Computer Vision and Pattern Recognition (CVPR), 2017, pp. 51225130.
[44] T.-Y. Lin, M. Maire, S. Belongie, L. Bourdev, R. Girshick, J. Hays, P. Perona, D. Ramanan, C. L. Zitnick, and P. Dollár, “Microsoft COCO: Common objects in context,” 2015. [Online]. Available: https://arxiv.org/abs/1405.0312
[45] Y. Liu, Y. Tian, Y. Zhao, H. Yu, L. Xie, Y. Wang, Q. Ye, and Y. Liu, “VMamba: Visual state space model,” 2024.
[46] Z. Liu, H. Mao, C.-Y. Wu, C. Feichtenhofer, T. Darrell, and S. Xie, “A ConvNet for the 2020s,” in Proceedings of the IEEE/CVF Conference on Computer Vision and Pattern Recognition (CVPR), June 2022, pp. 11976-11986.
[47] K. He, G. Gkioxari, P. Dollar, and R. Girshick, “Mask r-cnn,” in Proceedings of the IEEE International Conference on Computer Vision (ICCV), October 2017.
[48] T. Xiao, Y. Liu, B. Zhou, Y. Jiang, and J. Sun, “Unified perceptual parsing for scene understanding,” in Proceedings of the European Conference on Computer Vision (ECCV), September 2018.
[49] H. Cai, J. Li, M. Hu, C. Gan, and S. Han, “EfficientViT: Lightweight multi-scale attention for high-resolution dense prediction,” in Proceedings of the IEEE/CVF International Conference on Computer Vision (ICCV), 2023, pp. 17302-17313.

1. A system comprising:
a processor configured to execute instructions;
a computer-readable medium containing instructions for execution on the processor, the instructions causing the processor to perform steps of:
accessing a machine learning model including:
at least one encoder or one decoder, wherein the encoder is adapted to receive input embeddings to generate an encoded output, the decoder is adapted to receive output embeddings to generate a decoded output;
wherein the encoder or the decoder comprises an attention network for receiving token embeddings H to generate an updated embedding matrix by carrying out the steps of:
generating a query, a key, and a value from token embeddings;
splitting the query Q into a first query matrix Q̅ and a second query matrix \tilde{Q}, the key K into a first key K̅ matrix and a second key matrix \tilde{K}, and the value V into a first value matrix V̅ and a second value matrix \tilde{V};
generating a first embedding matrix H̅ using global linear attention from the first query matrix Q̅, the first key matrix K̅, and the first value matrix V̅;
generating a second embedding matrix \tilde{H} using sparse blockify attention from the second query matrix \tilde{Q}, the second key matrix \tilde{K}, and the second value matrix \tilde{V};
generating a third embedding matrix H by concentrating the first embedding matrix H̅ and the second embedding matrix \tilde{H}.

2. The system of claim 1, wherein the query, the key, and the value have same dimensions (m×c).

3. The system of claim 2, wherein the first query matrix Q̅, the first key matrix K̅, and the first value matrix V̅ have same dimensions (m×c₁), and wherein the second query matrix \tilde{Q}, the second key matrix \tilde{K}, and the second value matrix \tilde{V} have same dimensions (m×c₂), such that c=c₁+c₂.

4. The system of claim 3, wherein the second embedding matrix \tilde{H} is generated by applying a blockify function ƒ(⋅) for separating the second query matrix \tilde{Q}, the second key matrix \tilde{K}, and the second value matrix \tilde{V} with a size of [symbol] into b blocks (each block has a size of (m/b)×c₂).

5. The system of claim 4, wherein the second embedding matrix \tilde{H} is generated by applying a unblockify function g(⋅) to unblock b blocks of attentions derived from the blockified matrices (ƒ(\tilde{Q}), ƒ(\tilde{K}), and ƒ(\tilde{V})) to a single matrix with a size of m×c₂.

6. The system of claim 4, wherein the second embedding matrix \tilde{H} is generated by (exp(\tilde{Q}\tilde{K}^{τ})⊙Z)\tilde{V}, wherein ⊙ denotes a Hadamard product, Z∈ [symbol] is a matrix where Z=I_{b}⊗U_{(m/b)}, ⊗ denoting the Kronecker product, and U_{(m/b)}∈ [symbol] being the all-ones matrix.

7. The system of claim 1, wherein the first embedding matrix H̅ is an attention matrix such that H̅=exp(Q̅K̅^{τ})V̅.

8. The system of claim 7, wherein the first embedding matrix H is an attention matrix such that H̅=exp(Q̅)exp(K̅)^{τ}V̅.

9. The system of claim 8, wherein the attention network comprises a locally enhanced positional encoding (LePE) mechanism wherein the locally enhanced positional encoding comprises the step of carrying out a depthwise convolution operation L( ).

10. The system of claim 9, the second embedding matrix \tilde{H} is generated by applying a blockify function ƒ(⋅) for the value before carrying out the depthwise convolution operation L( ), such that \tilde{H}=g(exp(ƒ(\tilde{Q})ƒ(\tilde{K})^{τ})ƒ(\tilde{V})+L(ƒ(\tilde{V}))).

11. A method, comprising:
accessing a machine learning model in a processor wherein the process comprising memory with a finite size:
receiving input embeddings for at least one encoder to generate an encoded output, or receiving output embeddings for at least one decoder to generate a decoded output;
receiving token embeddings H to generate an updated embedding matrix by an attention network in the encoder or decoder by carrying the steps of:
generating a query, a key, and a value from token embeddings wherein the query, key, and value have a size greater than that of the memory;
splitting the query Q into a first query matrix Q̅ and a second query matrix \tilde{Q}, the key K into a first key K̅ matrix and a second key matrix \tilde{K}, and the value V into a first value matrix V̅ and a second value matrix \tilde{V};
generating a first embedding matrix H̅ using global linear attention from the first query matrix Q̅, the first key matrix K̅, and the first value matrix V̅;
generating a second embedding matrix \tilde{H} using sparse blockify attention from the second query matrix \tilde{Q}, the second key matrix \tilde{K}, and the second value matrix \tilde{V};
generating a third embedding matrix H by concentrating the first embedding matrix H̅ and the second embedding matrix \tilde{H}.

12. The method of claim 11, wherein the query, the key, and the value have same dimensions (m×c).

13. The system of claim 12, wherein the first query matrix Q̅, the first key matrix K̅, and the first value matrix V̅ have same dimensions (m×c₁), and wherein the second query matrix \tilde{Q}, the second key matrix \tilde{K}, and the second value matrix \tilde{V} have same dimensions (m×c₂), such that c=c₁+c₂.

14. The system of claim 13, wherein the second embedding matrix \tilde{H} is generated by applying a blockify function ƒ(⋅) for separating the second query matrix \tilde{Q}, the second key matrix \tilde{K}, and the second value matrix \tilde{V} with a size of m×c₂ into b blocks (each block has a size of (m/b)×c₂).

15. The system of claim 14, wherein the second embedding matrix \tilde{H} is generated by applying a unblockify function g(⋅) to unblock b blocks of attentions derived from the blockified matrices (ƒ(\tilde{Q}), ƒ(\tilde{K}), and ƒ(\tilde{V})) to a single matrix with a size of m×c₂.

16. The system of claim 14, wherein the sparse blockify attention \tilde{H} is generated by (exp(\tilde{Q}\tilde{K}^{τ})⊙Z)\tilde{V}, wherein ⊙ denotes a Hadamard product, Z∈ [symbol] is a matrix where Z=I_{b}⊗U_{(m/b)}, ⊗ denoting the Kronecker product, and U_{(m/b)}∈ [symbol] being the all-ones matrix.

17. The system of claim 11, wherein the first embedding matrix \tilde{H} is an embedding matrix such that \tilde{H}=exp(Q̅K̅^{τ})V̅.

18. The system of claim 17, wherein the first embedding matrix H̅ is an embedding matrix such that H̅=exp(Q̅)exp(K̅)^{τ}V̅.

19. The system of claim 18, wherein the attention network comprises a locally enhanced positional encoding (LePE) mechanism wherein the locally enhanced positional encoding comprises the step of carry out a depthwise convolution operation L( ).

20. The system of claim 19, the second embedding matrix \tilde{H} is generated by applying a blockify function ƒ(⋅) for the value before carrying out the depthwise convolution operation L( ), such that \tilde{H}=g(exp(ƒ(\tilde{Q})ƒ(\tilde{K})^{τ})ƒ(\tilde{V})+L(ƒ(\tilde{V}))).
